(19) United States
(12) Patent Application Publication
(10) Pub. No.: US 2019/0271929 A1
(43) Pub. Date: Sep. 5, 2019

(54) LIQUID DEVELOPER AND METHOD FOR MANUFACTURING LIQUID DEVELOPER

(71) Applicant: CANON KABUSHIKI KAISHA, Tokyo (JP)

(72) Inventors: Jun Shirakawa, Kawaguchi-shi (JP); Junji Ito, Hiratsuka-shi (JP); Yasuhiro Aichi, Tokyo (JP); Waka Hasegawa, Tokyo (JP); Ryo Natori, Tokyo (JP); Ayano Mashida, Kawasaki-shi (JP)

(21) Appl. No.: 16/418,301

(22) Filed: May 21, 2019

Related U.S. Application Data
(63) Continuation of application No. PCT/JP2017/041979, filed on Nov. 22, 2017.

(30) Foreign Application Priority Data
Nov. 25, 2016 (JP) 2016-229240
Jul. 27, 2017 (JP) 2017-145530

(51) Int. Cl. G03G 9/125; G03G 9/12; G03G 9/13; G03G 9/08; G03G 9/087

(52) U.S. Cl. CPC G03G 9/125; G03G 9/122; G03G 9/08755; G03G 9/0806; G03G 9/131

(57) ABSTRACT

Provided is a liquid developer with excellent image quality, fixability and storage stability, containing a toner particle with both good dispersion stability and good surface smoothness, the liquid developer contains an insulating liquid and a toner particle that is insoluble in the insulating liquid, and the toner particle contains a colorant having an acidic group and a binder resin, or a colorant and a binder resin having an acidic group, and a polyamine compound.

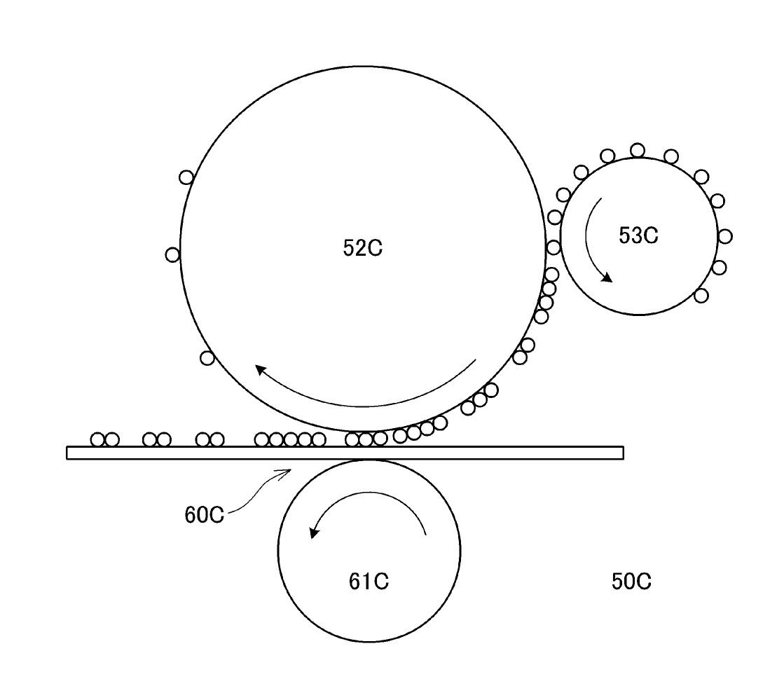

### CROSS-REFERENCE TO RELATED APPLICATIONS

This application is a Continuation of International Patent Application No. PCT/JP2017/041979, filed Nov. 22, 2017, which claims the benefits of Japanese Patent Application No. 2016-229240, filed Nov. 25, 2016, and Japanese Patent Application No. 2017-145530, filed Jul. 27, 2017, all of which are hereby incorporated by reference herein in their entirety.

### BACKGROUND OF THE INVENTION

### Field of the Invention

The present invention relates to a liquid developer for use in image-forming apparatuses using electrophotographic systems such as electrophotography, electrostatic recording and electrostatic printing, and to a method for manufacturing a liquid developer.

### Background Art

Electrophotographic systems are methods for obtaining printed matter by uniformly charging the surface of an image bearing member such as a photosensitive member (charging step), exposing the surface of the image bearing member to light to form an electrostatic latent image (exposure step), developing the formed electrostatic latent image with a developer comprised of colorant resin particles (developing step), transferring the developer image to a recording medium such as paper or plastic film (transfer step), and fixing the transferred developer image on the recording medium (fixing step).

The developers in this case can be classified broadly into dry developers that are used in a dry state and comprise colorant resin particles composed of a material containing a binder resin and a colorant such as a pigment, and wet developers comprised of colorant resin particles dispersed in an electrically insulating liquid.

In recent years, image forming apparatuses such as copiers, fax machines and printers using electrophotographic systems are being subjected to increased demands for color and high-speed printing. Because high-quality, high-resolution images are required for color printing, there is demand for developers that are suited to high speed printing and are also capable of forming high-quality, high-resolution images.

Liquid developers are known to be are useful for reproducing color images. With a liquid developer, a fine toner can be used because there is little risk of the colorant resin particles aggregating in the liquid developer during storage. Excellent fine line image reproducibility and tone reproduction characteristics are thus easy to obtain with a liquid developer. Many high-quality, high-speed digital printing apparatuses using liquid developers and electrophotographic technology have been developed to exploit these excellent characteristics. Under these circumstances, there is demand for the development of liquid developers having further improved characteristics.

Conventionally, liquid developers manufactured by coacervation methods have been developed with the aim of obtaining liquid developers with excellent dispersion stability and optical characteristics (PTL 1).

Liquid developers are also known comprising colorant resin particles dispersed in electrically insulating liquids such as organic hydrocarbon solvents or silicone oil. However, it has been necessary to remove the electrically insulating liquid because there may be a significant reduction in image quality if the electrically insulating liquid remains on the paper, plastic film or other recording medium. A common method of removing the electrically insulating liquid is to volatilize it by applying thermal energy. However, this creates a risk of organic solvent vapor escaping outside the apparatus, as well as requiring large quantities of energy, so this method is not necessarily desirable from an environmental or energy savings perspective.

To combat this, methods have been proposed for curing the electrically insulating liquid by photopolymerization. Photocurable liquid developers include those obtained by using a monomer or oligomer having a reactive functional group as an electrically insulating liquid, and dissolving a photopolymerization initiator therein. Such a photocurable liquid developer is also suited to high speeds because it is cured by exposing it to light such as UV rays to react the reactive functional group.

As a photocurable liquid developer, PTL 2 proposes a photocurable liquid developer using a cationically polymerizable liquid monomer as a monomer having a reactive functional group.

### CITATION LIST

### Patent Literature

PTL 1 WO 2007/000974

PTL 2 Japanese Patent Application Publication No. 2015-127812

To obtain a liquid developer that is highly transportable and able to be highly concentrated and provides excellent image quality, it is necessary to improve the dispersion stability and surface smoothness of the toner particle. However, the toner particle in the liquid developer disclosed in PTL 1 provides poor image quality because it is unsatisfactory in either or both of dispersion stability and surface smoothness.

In the case of liquid developers using polymerizable liquid compounds, on the other hand, there have been problems of storage stability because dark reactions are likely to occur when carbon black is used as a colorant.

Polymerization inhibitors such as amine compounds have been added to liquid developers in an effort to suppress dark polymerization reactions and improve storage stability in environments not exposed to light.

When dissolved in polymerizable liquid compounds, polymerization inhibitors do indeed increase storage stability by suppressing dark polymerization reactions. However, polymerization inhibitors dissolved in polymerizable liquid compounds also inhibit photocuring reactions during image fixing by light exposure. Consequently, there is demand for development of methods to increase the storage stability of liquid developers without compromising fixability by inhibiting polymerization.

The present invention provides a liquid developer excellent in image quality, fixability and storage stability and having a toner particle with both good dispersion stability and good surface smoothness, as well as a method for manufacturing the liquid developer.

### SUMMARY OF THE INVENTION

The present invention relates to a liquid developer containing an insulating liquid and a toner particle that is insoluble in the insulating liquid, wherein

the toner particle contains:
a polyamine compound, and
a binder resin and a colorant having an acidic group, or a colorant and a binder resin having an acidic group.

The present invention also relates to a method for manufacturing a liquid developer containing

an insulating liquid and

a toner particle that contains:
a polyamine compound, and
a binder resin and a colorant having an acidic group, or a colorant

and a binder resin having an acidic group,

the method comprising

a step 1 of preparing a mixture containing

an insulating liquid,

a binder resin and a colorant having an acidic group, or a colorant and a binder resin having an acidic group,

a polyamine compound, and

a solvent, and

a step 2 of removing the solvent from the mixture, wherein

the binder resin does not dissolve in the insulating liquid but dissolves in the solvent.

Further features of the present invention will become apparent from the following description of exemplary embodiments with reference to the attached drawings.

### BRIEF DESCRIPTION OF THE DRAWINGS

The FIGURE shows an outline of a developing apparatus.

### DESCRIPTION OF THE EMBODIMENTS

Unless otherwise specified, descriptions of numerical ranges such as “at least XX and not more than YY” or “XX to YY” in the present invention include the numbers at the upper and lower limits of the range.

Moreover, a monomer unit is a reacted form of a monomer substance in a polymer or resin.

Features of the liquid developer of the invention are that the liquid developer contains an insulating liquid and a toner particle that is insoluble in the insulating liquid, and the toner particle contains a polyamine compound, and a binder resin and a colorant having an acidic group, or a colorant and a binder resin having an acidic group.

The dispersion stability and surface smoothness of the toner particle are improved when the toner particle contains a polyamine compound.

The reasons for this are unknown, but are presumed to be as follows.

It is thought that the polyamine compound exists in the toner particle in a state of interaction with the colorant having an acidic group or the binder resin having an acidic group.

It is also thought that when the polyamine compound is incorporated into the toner particle, it improves the dispersion stability of the toner particle by preventing aggregation between toner particles, and also improves the surface smoothness of the toner particle by plasticizing the resin near the surface of the toner particle.

In liquid developers using polymerizable liquid compounds, moreover, there may be problems of storage stability because dark polymerization reactions are likely to occur when using colorants such as carbon black that contain acidic groups.

By contrast, when the toner particle contains a polyamine compound, such dark polymerization reactions are suppressed and good storage stability is obtained. The reason for this is not certain, but it is thought that a polyamine compound with a high cation density acts as a base to neutralize the acidic groups on the surface of the carbon black, thereby preventing these acidic groups from becoming initiation species of polymerization reactions under dark conditions.

Moreover, in general basic substances such as amine compounds exhibit polymerization inhibition in polymerizable liquid compounds. However, it is thought that because polyamine compounds are polymers, they are less likely than low-molecular-weight amine compounds to cause polymerization inhibition because elution from the toner particle into the polymerizable liquid compound is suppressed.

Each of the components contained in the liquid developer is explained below.

### <Toner Particle>

As discussed above, the toner particle contains a polyamine compound, and a binder resin and a colorant having an acidic group, or a colorant and a binder resin having an acidic group.

The toner particle may also contain a polyamine compound, and a colorant having an acidic group and a binder resin having an acidic group.

The toner particle is also insoluble in the insulating liquid. “Insoluble in the insulating liquid” here may be indicated by the fact that not more than 1 mass part of the toner particle dissolves in 100 mass parts of the insulating liquid at 25° C.

### <Binder Resin>

A known binder resin that is fixable on adherends such as paper and plastic and is insoluble in the insulating liquid may be used as the binder resin. “Insoluble in the insulating liquid” here may be indicated by the fact that not more than 1 mass part of the binder resin dissolves in 100 mass parts of the insulating liquid at 25° C.

The benchmark for a binder resin having an acidic group may be that the acid value of the binder resin is at least 2 KOHmg/g. The acidic group is not particularly limited, but examples include carboxyl and sulfone groups.

Examples of the binder resin include epoxy resins, polyester resins, vinyl resins such as ethylene-(meth)acrylic resin, (meth)acrylic resin or styrene-(meth)acrylic resin, alkyd resins, polyethylene resins, polyurethane resins, polyamide resins, polyimide resins, silicone resins, phenol resins, melamine resins, urea resins, aniline resins, ionomer resins, polycarbonate resins, and rosin-modified resins. One of these alone or a combination of two or more may be used as necessary. Of these, an epoxy resin, a polyester resin, a vinyl resin such as ethylene-(meth)acrylic resin, (meth)acrylic resin or styrene-(meth)acrylic resin, or a polyurethane resin is preferred.

The binder resin more preferably contains a polyester resin. The content of the polyester resin in the binder resin is preferably at least 50 mass %, or more preferably at least 60 mass %, or still more preferably at least 80 mass %.

The content of the binder resin is not particularly limited, but is preferably from 50 to 1,000 mass parts per 100 mass parts of the colorant.

The acid value of the binder resin is preferably from 5 mgKOH/g to 150 mgKOH/g, or more preferably from 5 mgKOH/g to 100 mgKOH/g, or still more preferably from 5 mgKOH/g to 50 mgKOH/g.

If the acid value of the binder resin is at least 5 mgKOH/g, interactions with the polyamine compound are stronger, and a toner particle aggregation prevention effect can be obtained while improving the surface smoothness of the toner particle.

The polyester resin is preferably a condensation product of a diol and a dicarboxylic acid and/or tricarboxylic acid.

Examples of the diol include ethylene glycol, propylene glycol, neopentyl glycol, and bisphenol A ethylene oxide adduct and/or propylene oxide adduct.

Examples of the dicarboxylic acid include terephthalic acid, isophthalic acid, orthophthalic acid and fumaric acid.

Examples of the tricarboxylic acid include trimellitic acid.

Examples of monomers used for the vinyl resin include styrene, (meth)acrylic acid, methyl (meth)acrylate and butyl (meth)acrylate.

The acid value of the binder resin can be controlled by controlling either the molar ratio of monomer units derived from acrylic acid or methacrylic acid as a percentage of the total monomer units constituting the binder resin, or the number of terminal groups in the polyester resin and the number of carboxyl groups among the terminal groups.

### <Polyamine Compound>

As discussed above, when the toner particle contains a polyamine compound the dispersion stability and surface smoothness of the toner particle are improved. In a liquid developer using a polymerizable liquid compound, dark polymerization reactions and polymerization inhibition are suppressed and good storage stability and fixability are obtained if the toner particle contains a polyamine compound.

This polyamine compound is insoluble in the insulating liquid. The benchmark for “insoluble in the insulating liquid” here may be that not more than 10 mass parts of the polyamine compound dissolve in 100 mass parts of the insulating liquid at 25° C.

The amine value of the polyamine compound is preferably at least 300 mgKOH/g, or more preferably at least 900 mgKOH/g.

There is no particular upper limit, but preferably it is not more than 1500 mgKOH/g.

If the amine value of the polyamine compound is at least 300 mgKOH/g, solubility in the insulating liquid is appropriate, and the dispersion stability and surface smoothness of the toner particle are particularly improved.

The weight-average molecular weight (Mw) of the polyamine compound is preferably from 300 to 70,000, or more preferably from 800 to 30,000, or still more preferably from 1,000 to 26,000.

The polyamine compound preferably includes at least one selected from the group consisting of polyethylenamine compounds, polyvinylamine compounds, polyallylamine compounds, and salts of these compounds. Of these, a polyallylamine compound or salt thereof is more preferred.

The content of the polyallylamine compound is preferably from 0.01 to 15 mass parts, or more preferably from 0.01 to 10 mass parts, or still more preferably from 0.2 to 10 mass parts, or especially from 0.2 to 8 mass parts per 100 mass parts of the colorant having an acidic group or the binder resin having an acidic group.

The polyallylamine compound is for example of a polymer having a monomer unit represented by formula (a) below.

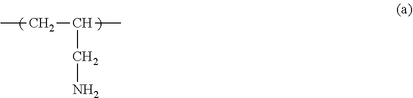

The number of monomer units represented by formula (a) above in one molecule of the polyallylamine compound is preferably 5 to 500, or more preferably 25 to 300, or still more preferably 25 to 150.

If the average number of monomer units represented by formula (a) above is within this range, solubility in the insulating liquid is appropriate, and the dispersion stability and surface smoothness of the toner particle are particularly improved.

The average number of monomer units represented by the formula (a) can be calculated by a method such as the following.

The weight-average molecular weight is calculated based on polystyrene conversion using gel permeation chromatography (GPC), and divided by the formula quantity of monomer units represented by formula (a) to calculate the number. The method for measuring molecular weight by GPC is as follows.

The sample is added to an eluent to a sample concentration of 1.0 mass %, and dissolved by standing for 24 hours at room temperature, and the resulting solution is filtered through a solvent-resistant membrane filter with a pore diameter of 0.20 μm to obtain a sample solution that is then measured under the following conditions.

Apparatus: HLC-8220 GPC high-speed GPC unit [Tosoh Corporation]
Columns: LF-804 (2-coupled)

### Eluent: Tetrahydrofuran (THF)

Flow rate: 1.0 mL/min
Oven temperature: 40° C.
Sample injection volume: 0.025 mL

A molecular weight calibration curve prepared using standard polystyrene resin [product name: TSK standard polystyrene F-850, F-450, F-288, F-128, F-80, F-40, F-20, F-10, F-4, F-2, F-1, A-5000, A-2500, A-1000, A-500, Tosoh Corporation] is used for calculating the molecular weights of the samples.

Commercial polyamine compounds and polyamine compound solutions may be used as mixtures containing a high concentration of the polyamine compound. Examples of commercial polyamine compounds and polyamine compound solutions include PAA-01, PAA-03, PAA-05, PAA-08, PAA-15 PAA-15C, PAA-25 and PAA-03E Nittobo Medical Co, Ltd.), SP-018 and SP-200 (Nippon Shokubai Co., Ltd.), Lupasol FG, Lupasol PR 8515 and Lupasol WF (BASF), PVAM-0595B and PVAM-0570B (Mitsubishi Rayon Co., Ltd.), and Polypyrrole (Sigma-Aldrich).

All common commercially available organic pigments, organic dyes, inorganic pigments and the like may be used as the colorant, without any particular

Examples of yellow colorants include C.I. pigment yellow 1, 3, 4, 5, 6, 7, 10, 11, 1, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181 and 185; and C.I. vat yellow 1, 3, 20.

Examples of red or magenta colorants include CI pigment red 1, 2, 3, 4, 5, 6, 1, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238 and 269; CI pigment violet 19; and C.I. vat red 1, 2, 10, 13, 15, 23, 29, 35.

Examples of blue or cyan colorants include C.I. pigment blue 2, 15:2, 15:3, 15:4, 16, and 17; C.I. vat blue 6; and C.I. acid blue 45 and copper phthalocyanine pigments having 1 to 5 phthalimidomethyl substituents in the phthalocyanine framework.

Examples of green colorants include CI pigment green 7, 8 and 36. Examples of orange colorants include C.I. pigment orange 66 and 51.

Examples of black pigments include carbon black, titanium black and aniline black.

Examples of white pigments include basic lead carbonate, zinc oxide, titanium oxide and strontium titanate.

The acidic group of the colorant having an acidic group is not particularly limited, but may be a carboxyl group or sulfone group.

A typical example of a colorant having such an acidic group is carbon black.

The carbon black is not particularly limited, and examples include all commercially available carbon blacks, carbon blacks dispersed in insoluble resins as dispersion media, and carbon blacks with resins grafted to the surface.

The pH of the carbon black is preferably basic. Because a basic carbon black interacts little with the toner particle dispersant, it is unlikely to be exposed on the toner particle surface in the process of particle formation when the toner particle is prepared. The pH of the carbon black is preferably 8.0 or more, or more preferably pH 9.0 or more. There is no particular upper limit, but preferably the pH is 13.0 or less.

The pH of the carbon black can be measured with a pH meter after stirring a 10 mass % carbon black/deionized water suspension for 1 minute at room temperature and then dropping in 5 drops of ethanol.

2 or more kinds of pigments may also be used together with the carbon black in order to adjust the color tone.

### <Insulating Liquid>

The insulating liquid exhibits electrically insulating properties, and preferably has a volume resistivity of from 1×10⁹ Ω·cm to 1×10¹³ Ω·cm.

The viscosity of the insulating liquid is preferably 0.5 mPa·s to less than 100 mPa·s, or more preferably 0.5 mPa·s to less than 20 mPa·s at 25° C.

The SP value of the insulating liquid is preferably from 7.0 to 9.0, or more preferably from 7.5 to 8.5, A resin that does not dissolve in an insulating liquid with an SP value of from 7.0 to 9.0 can then be used as the binder resin.

The SP value is the solubility parameter. The SP value is a value introduced by Hildebrand and defined by normal theory, and is a benchmark of the solubility of a 2-component solution, indicated by the square root of the cohesive energy density of the solvent (or solute). In the present invention, the SP value is a value calculated from the evaporation energy and molar volume of atoms or atomic groups by the Fedors method as described in Coating Basics and Engineering (page 53, Yuji Harasaki, Processing Technology Study Group). The SP value is given in units of (cal/cm³)^{1/2}, but these can be converted to units of (J/m³)^{1/2} using the formula 1 (cal/cm³)^{1/2}=2.046×10³ (J/m³)^{1/2}.

Examples of insulating liquids include hydrocarbon solvents such as octane, isooctane, decane, isodecane, decalin, nonane, dodecane and isododecane; and paraffin solvents such as Isopar E, Isopar G, Isopar H, Isopar L, Isopar M and Isopar V (Exxon Mobil), ShellSol A100 and ShellSol A150 (Shell Chemicals Japan) and Moresco White MT-30P (Matsumura Oil); and the like.

To make the liquid developer a curable liquid developer, a polymerizable liquid compound may be used for the insulating liquid. The polymerizable liquid compound is not particularly limited as long as it has the physical properties of the insulating liquid described above.

The polymerizable liquid compound may be a component that can be polymerized by a photopolymerization reaction.

The photopolymerization reaction may be a reaction using any kind of light, but is preferably a reaction using UV rays. That is, the insulating liquid may be a UV-curable polymerizable liquid compound.

Examples of polymerizable liquid compounds include radical polymerizable compounds, cationically polymerizable compounds and those having both properties, and any of these can be used favorably.

Examples include vinyl ether compounds, urethane compounds, styrene compounds and acrylic compounds, as well as cyclic ether compounds such as epoxy compounds and oxetane compounds. One of these compounds alone or a combination of two or more may be used as the polymerizable liquid compound.

The polymerizable liquid compound preferably includes a cationically polymerizable liquid monomer, and more preferably includes a vinyl ether compound.

Using such a vinyl ether compound, it is possible to obtain a highly sensitive UV-curable liquid developer with high volume resistivity and low viscosity.

A vinyl ether compound here is a compound having a vinyl ether structure (—CH═CH—O—C—).

This vinyl ether structure is preferably represented by RLCH═CH—O—C— (in which R′ is a hydrogen or C₁₋₃ alkyl, and is preferably a hydrogen or methyl).

It is presumed that good characteristics are obtained because there is little bias in electron density within the vinyl ether compound molecule.

A wide range of acrylic monomers and cyclic ether monomers such as epoxy and oxetane may be used as cationically polymerizable liquid monomers. However, because acrylic monomers have electron density bias in the molecule they are subject to static interactions between molecules, which makes it difficult to obtain a low-viscosity liquid developer and also tends to reduce resistance. It is also hard to obtain high volume resistivity with cyclic ether monomers, which also have low reaction speeds in comparison with vinyl ether compounds.

In a preferred embodiment, the vinyl ether compound is a compound having no hetero atoms outside the vinyl ether structure.

A hetero atom here is an atom other than a carbon atom or hydrogen atom.

With a compound having no hetero atoms outside the vinyl ether structure, electron density bias in the molecule is controlled, and it is easier to obtain high volume resistivity.

In another preferred embodiment, the vinyl ether compound contains no carbon-carbon double bonds outside the vinyl ether structure. With a vinyl ether compound containing no carbon-carbon double bonds outside the vinyl ether structure, electron density bias is controlled, and it is easier to obtain high volume resistivity.

This vinyl ether compound is preferably represented by formula (b) below.

(H₂C═CH—O)ₙ—R (b)

where n is an integer of from 1 to 4 representing the number of vinyl ether structures in one molecule, and R is an n-valent hydrocarbon group.

The n is preferably an integer of from 1 to 3.

R is preferably a group selected from the C₁₋₂₀ linear or branched, saturated or unsaturated aliphatic hydrocarbon groups, C₅₋₁₂ saturated or unsaturated alicyclic hydrocarbon groups and C₆₋₁₄ aromatic hydrocarbon groups, and the alicyclic hydrocarbon group or aromatic hydrocarbon group may also have a C₁₋₄ saturated or unsaturated aliphatic hydrocarbon group.

This R is more preferably a C₄₋₁₈ linear or branched saturated aliphatic hydrocarbon group.

Specific examples of the vinyl ether compound are given below (example compounds A-1 to A-31), but the invention is not limited by these examples.

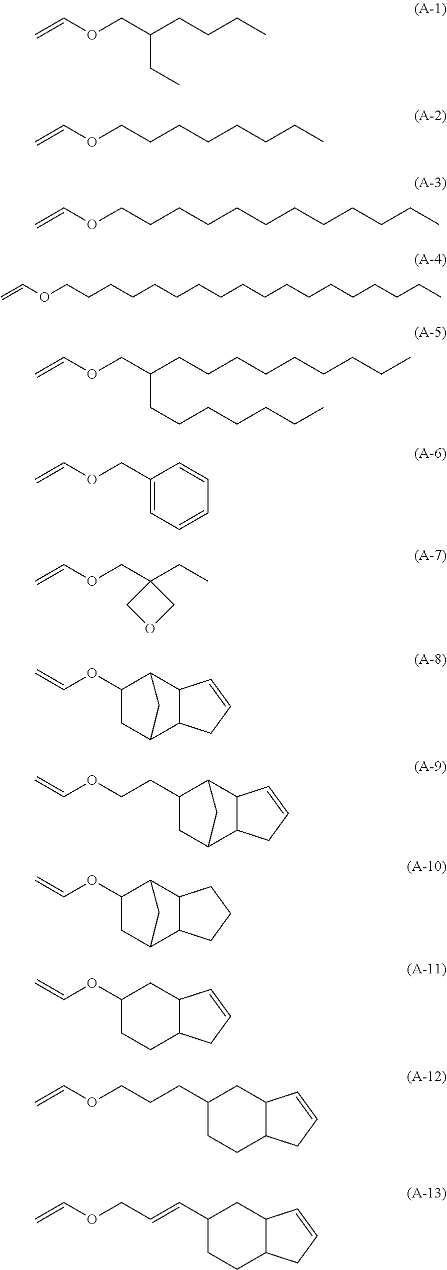

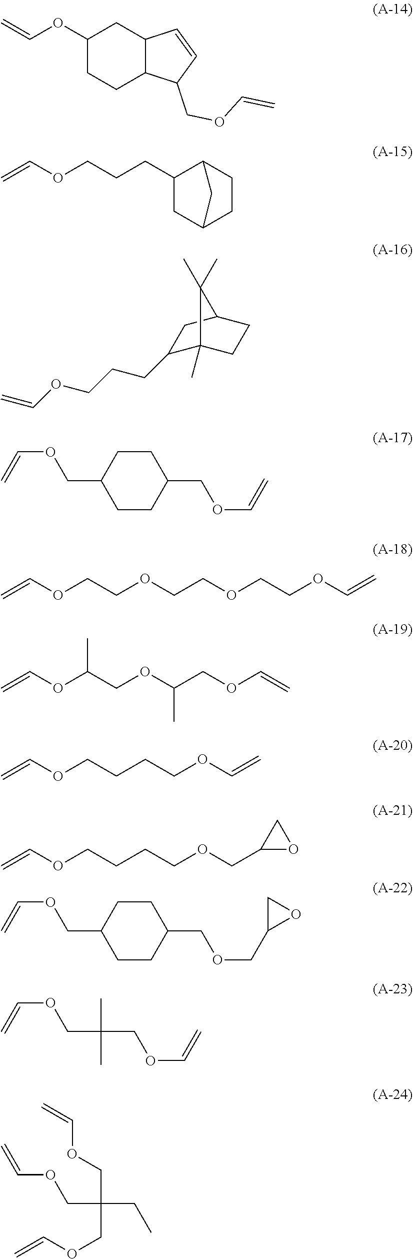

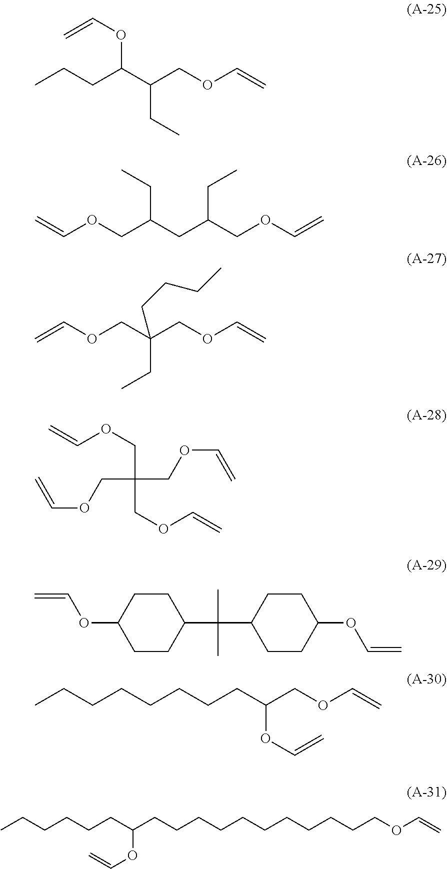

Of these, desirable examples include dodecyl vinyl ether (A-3), dicyclopentadiene vinyl ether (A-8), cyclohexane dimethanol divinyl ether (A-17), tricyclodecane vinyl ether (A-10), dipropylene glycol divinyl ether (A-19), trimethylol propane trivinyl ether (A-24), 2-ethyl-1,3-hexanediol divinyl ether (A-25), 2,4-diethyl-1,5-pentanediol divinyl ether (A-26), 2-butyl-2-ethyl-1,3-propanediol divinyl ether (A-27), neopentyl glycol divinyl ether (A-23), pentaerythritol tetravinyl ether (A-28), 1,2-decanediol divinyl ether (A-30) and 1,12-octadecanediol divinyl ether (A-31).

<Polymerization Initiator>

A reaction called an initiation reaction is necessary to initiate the polymerization reaction of the polymerizable liquid compound. The substance used for this purpose is the polymerization initiator.

When the polymerizable liquid compound is a component that can be polymerized by a photopolymerization reaction, a photopolymerization initiator that generates acids and radicals in response to light of a specific wavelength may be used.

From the perspective of preventing a decrease in the volume resistivity of the polymerizable liquid compound, a photopolymerization initiator represented by formula (3) below may be used.

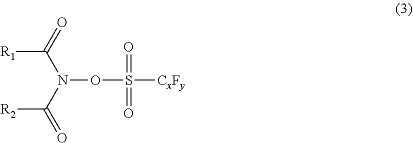

where R₁ and R₂ bond together to form a cyclic structure, x represents an integer of from 1 to 8, and y represents an integer of from 3 to 17.

This photopolymerization initiator is photo-decomposed by UV irradiation, generating the strong acid sulfonic acid. This can also be used in combination with a sensitizer, which absorbs UV rays and acts as a trigger for decomposing the polymerization initiator and producing sulfonic acid.

The cyclic structure formed by bonding between R₁ and R₂ may be a 5-member ring or 6-member ring for example. Specific examples of cyclic structures formed by bonding between R₁ and R₂ include succinimide structures, phthalimide structures, norbornene dicarboximide structures, naphthalene dicarboximide structures, cyclohexane dicarboximide structures and epoxycyclohexene dicarboximide structures.

This cyclic structure may also have an alkyl, alkyloxy, alkylthio, aryl, aryloxy, arylthio group or the like as a substituent.

The highly electron-withdrawing CₓF_{y} group is a fluorocarbon group that serves as a functional group for decomposing the sulfonic acid ester part by UV exposure, and preferably has 1 to 8 carbon atoms (x=1 to 8) and 3 to 17 fluorine atoms (y=3 to 17).

Examples of CₓF_{y} in the formula (3) include linear alkyl groups in which fluorine atoms are substituted for hydrogen atoms (RF1), branched alkyl groups in which fluorine atoms are substituted for hydrogen atoms (RF2), cycloalkyl groups in which fluorine atoms are substituted for hydrogen atoms (RF3) and aryl groups in which fluorine atoms are substituted for hydrogen atoms (RF4).

Examples of linear alkyl groups in which fluorine atoms are substituted for hydrogen atoms (RF1) include trifluoromethyl (x=1, y=3), pentafluoroethyl (x=2, y=5), heptafluoro-n-propyl (x=3, y=7), nonafluoro-n-butyl (x=4, y=9), perfluoro-n-hexyl (x=6, y=13) and perfluoro-n-octyl (x=8, y=17) groups and the like.

Examples of branched alkyl groups in which fluorine atoms are substituted for hydrogen atoms (RF2) include perfluoroisopropyl (x=3, y=7), perfluoro-tert-butyl (x=4, y=9), and perfluoro-2-ethylhexyl (x=8, y=17) groups and the like.

Examples of cycloalkyl groups in which fluorine atoms are substituted for hydrogen atoms (RF3) include perfluorocyclobutyl (x=4, y=7), perfluorocyclopentyl (x=5, y=9), perfluorocyclohexyl (x=6, y=11) and perfluoro(1-cyclohexyl)methyl (x=7, y=13) groups and the like.

Examples of aryl groups in witch fluorine atoms are substituted for hydrogen atoms (RF4) include pentafluorophenyl (x=6, y=5) and 3-trifluoromethyl tetrafluorophenyl (x=7, y=7) groups and the like.

From the perspective of availability and degradability of the sulfonic acid ester portion, a linear alkyl group (RF1), branched alkyl group (RF2) or aryl group (RF4) is preferred for CₓF_{y} in formula (3) above. A linear alkyl group (RF1) or aryl group (RF4) is more preferred. A trifluoromethyl group (x=1, y=3), pentafluoroethyl group (x=2, y=5), heptafluoro-n-propyl group (x=3, y=7), nonafluoro-n-butyl group (x=4, y=9) or pentafluorophenyl group (x=6, y=5) is still more desirable.

One kind of photopolymerization initiator alone or a combination of two or more kinds may be used.

The content of the photopolymerization initiator is not particularly limited, but is preferably from 0.01 to 5 mass parts, or more preferably from 0.05 to 1 mass part, or still more preferably from 0.1 to 0.5 mass parts per 100 mass parts of the cationically polymerizable liquid monomer.

Specific examples of the photopolymerization initiator represented by formula (3) (example compounds B-1 to B-27) are given below, but the present invention is not limited by these examples.

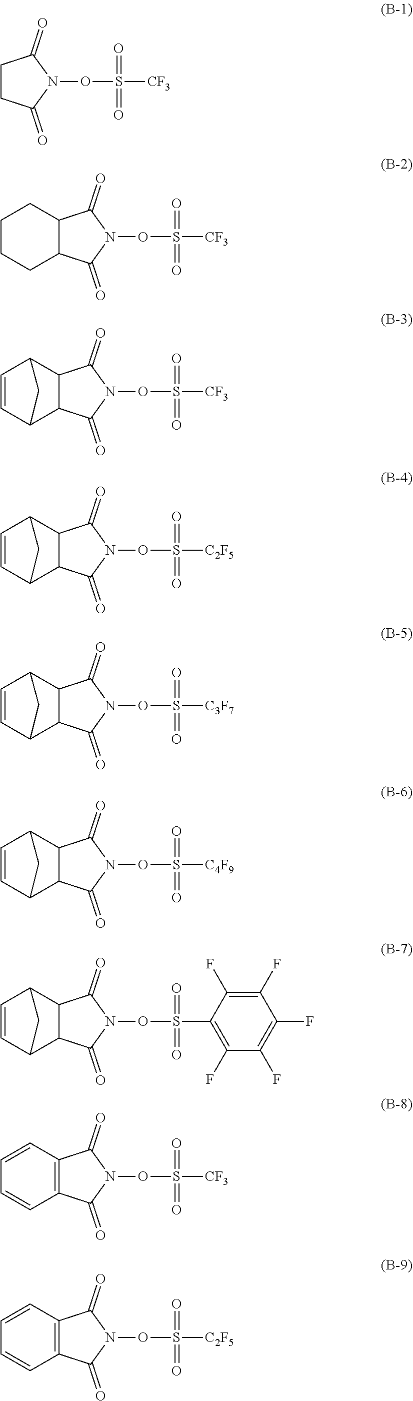

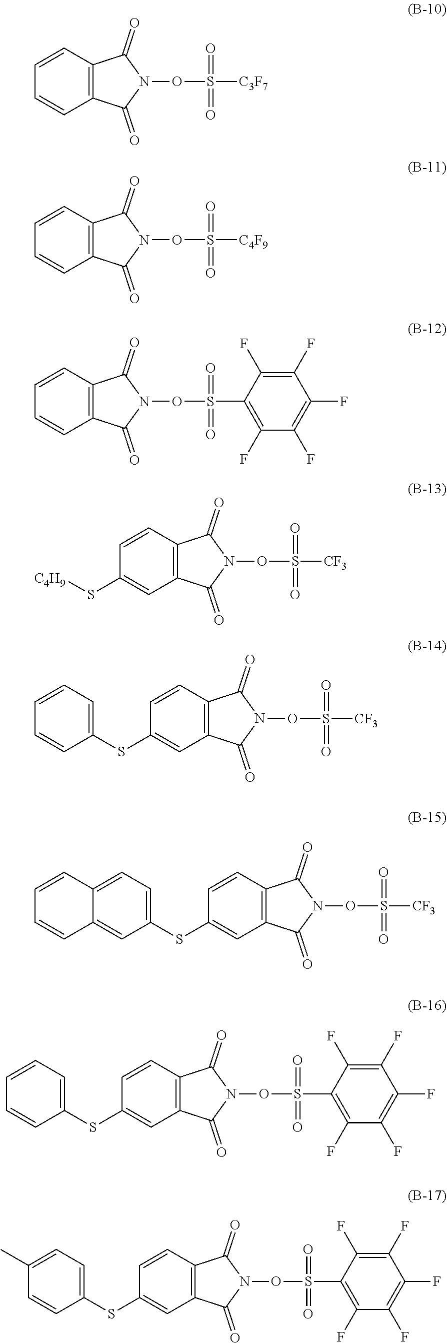

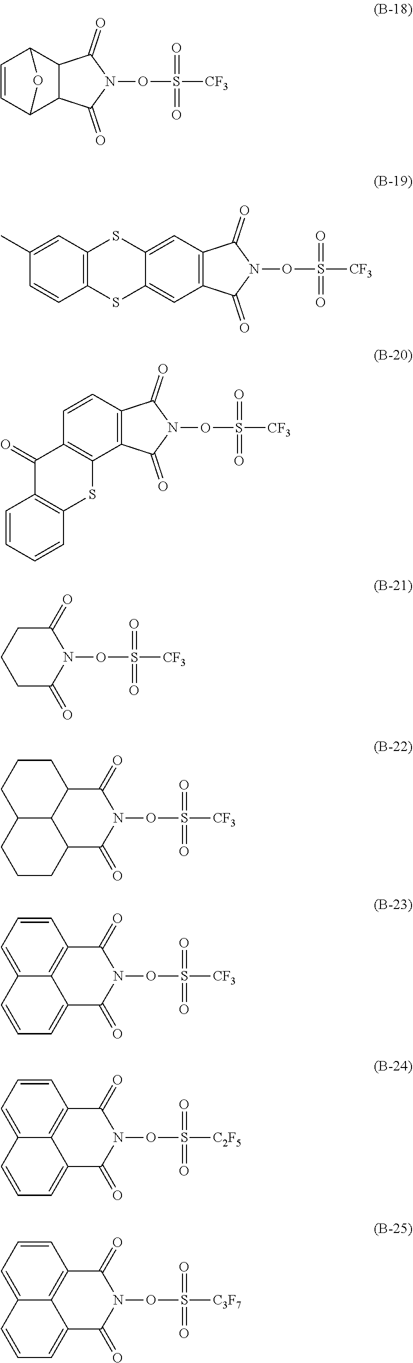

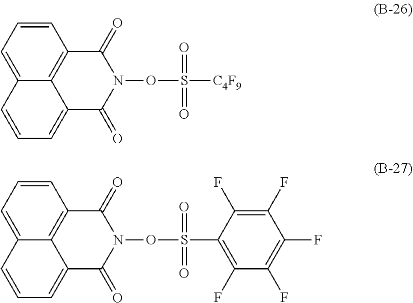

<Sensitizer and Sensitizing Aid>

A sensitizer may also be included in the liquid developer as necessary in order to improve the acid generating efficiency of the photopolymerization initiator and increase the photosensitizing wavelength and the like.

The sensitizer is not particularly limited as long as it increases sensitivity to the photopolymerization initiator by an electron transfer mechanism or energy transfer mechanism.

Specific examples include aromatic polycondensed ring compounds such as anthracene, 9,10-dialkoxyanthracene, pyrene and perylene, aromatic ketone compounds such as acetophenone, benzophenone, thioxanthone and Michler's ketone, and heterocyclic compounds such as phenothiazine and N-aryloxazolidinone.

The content of the sensitizer may be selected appropriately according to the object, but is normally from 0.1 to 10 mass parts, or preferably from 1 to 5 mass parts per 1 mass part of the photopolymerization initiator.

A sensitizing aid may also be included in the liquid developer with the aim of increasing the electron transfer efficiency or energy transfer efficiency between the sensitizer and the photopolymerization initiator.

Specific examples include naphthalene compounds such as 1,4-dihydroxynaphthalene, 1,4-dimethoxynaphthalene, 1,4-diethoxynaphthalene, 4-methoxy-1-naphthol and 4-ethoxy-1-naphthol, and benzene compounds such as 1,4-dihydroxybenzene, 1,4-dimethoxybenzene, 1,4-diethoxybenzene, 1-methoxy-4-phenol and 1-ethoxy-4-phenol.

The content of the sensitizing aid may be selected appropriately according to the object, but is preferably from 0.1 to 10 mass parts, or more preferably from 0.5 to 5 mass parts per 1 mass part of the sensitizer.

<Cationic Polymerization Inhibitor>

The liquid developer may also contain a cationic polymerization inhibitor.

The cationic polymerization initiator may be an alkaline metal compound and/or alkaline earth metal compound, or an amine.

Examples of amines include alkanolamines, N,N-dimethylalkylamines, N,N-dimethylakenylamines, N,N-dimethylalkynylamines and the like.

Specific examples include triethanolamine, triisopropanolamine, tributanolamine, N-ethyldiethanolamine, propanolamine, n-butylamine, sec-butylamine, 2-aminoethanol, 2-methylaminoethanol, 3-methylamino-1-propanol, 3-methylamino-1,2-propanediol, 2-ethylaminoethanol, 4-ethylamino-1-butanol, 4-(n-butylamino)-1-butanol, 2-(t-butylamino)ethanol, N,N-dimethylundecanolamine, N,N-dimethyldodecanolamine, N,N-dimethyltridecanolamine, N,N-dimethyltetradecanolamine, N,N-dimethylpentadecanolamine, N,N-dimethylnonadecylamine, N,N-dimethylicosylamine, N,N-dimethyleicosylamine, N,N-dimethylheneicosylamine, N,N-dimethyldocosylamine, N,N-dimethyltricosylamine, N,N-dimethyltetracosylamine, N,N-dimethylpentacosylamine, N,N-dimethylpentanolamine, N,N-dimethylhexanolamine, N,N-dimethylheptanolamine, N,N-dimethyloctanolamine, N,N-dimethylnonanolamine, N,N-dimethyldecanolamine, N,N-dimethylnonylamine, N,N-dimethyldecylamine, N,N-dimethylundecylamine, N,N-dimethyldodecylamine, N,N-dimethyltridecylamine, N,N-dimethyltetradecylamine, N,N-dimethylpentadecylamine, N,N-dimethylhexadecylamine, N,N-dimethylheptadecylamine and N,N-dimethyloctadecylamine. A quaternary ammonium salt or the like may also be used. A secondary amine is particularly desirable as the cationic polymerization inhibitor.

The content of the cationic polymerization inhibitor is preferably 1 to 5000 ppm based on mass in the liquid developer.

<Radical Polymerization Inhibitor>

The liquid developer may also contain a radical polymerization inhibitor.

For example, in a liquid developer containing a vinyl ether compound the photopolymerization initiator may be slightly decomposed during storage over time, become radical compounds and causing polymerization due to the radical compounds. The inhibitor is added to prevent this.

Examples of suitable radical polymerization inhibitors include phenolic compounds containing hydroxyl groups, quinones such as methoquinone (hydroquinone monomethyl ether), hydroquinone and 4-methoxy-1-naphthol, hindered amine antioxidants, 1,1-diphenyl-2-picrylhydrazyl free radical, N-oxyl free radical compounds, nitrogen-containing heterocyclic mercapto compounds, thioether antioxidants, hindered phenol antioxidants, ascorbic acids, zinc sulfate, thiocyanate salts, thiourea derivatives, various sugars, phosphoric acid antioxidants, nitrites, nitrates, sulfites, thiosulfates, hydroxylamine derivatives, aromatic amines, phenylenediamines, imines, sulfonamides, urea derivatives, oximes, polycondensates of dicyandiamide and polyalkylene polyamines, sulfur-containing compounds such as phenothiazine, complexing agents based on tetraaza annulene (TAA), and hindered amines and the like.

To prevent an increase in the viscosity of the liquid developer, phenolic compounds containing hydroxyl groups, N-oxyl free radical compounds, 1,1-diphenyl-2-picrylhydrazyl free radical, phenothiazine, quinones and hindered amines are preferred. An N-oxyl free radical compound is especially desirable.

The content of the radical polymerization inhibitor is preferably 1 to 5000 ppm based on mass in the liquid developer.

<Charge Control Agent>

The liquid developer may also contain a charge control agent as necessary. A known charge control agent may be used.

The following are examples of specific compounds:

oils and fats such as linseed oil and soybean oil; alkyd resins, halogen polymers, aromatic polycarboxylic acids, water-soluble dyes containing acidic groups, oxidized condensates of aromatic polyamines, and metal soaps such as cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate and cobalt 2-ethylhexanoate; sulfonic acid metal salts such as petroleum-based sulfonic acid metal salts and metal salts of sulfosuccinic acid esters; phospholipids such as hydrogenated lecithin and lecithin; salicylic acid metal salts such as t-butyl salicylic acid metal complexes; and polyvinylpyrrolidone resins, polyamide resins, sulfonic acid-containing resins, and hydroxybenzoic acid derivatives.

<Charge Adjuvants>

A charge adjuvant may also be included in the toner particle to adjust the charging performance of the toner particle. A known charge adjuvant may be used.

Examples of specific compounds include metal soaps such as zirconium naphthenate, cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, aluminum tristearate and cobalt 2-ethylhexanoate; sulfonic acid metal salts such as petroleum-based sulfonic acid metal salts and metal salts of sulfosuccinic acid esters; phospholipids such as hydrogenated lecithin and lecithin; salicylic acid metal salts such as t-butyl salicylic acid metal complexes; and polyvinylpyrrolidone resins, polyamide resins, sulfonic acid-containing resins, and hydroxybenzoic acid derivatives.

<Other Additives>

In addition to those explained above, various known additives such as surfactants, lubricants, fillers, antifoaming agents, UV absorbers, antioxidants, anti-fading agents, antifungal agents and rust inhibitors may be selected appropriately and used in the liquid developer as necessary to improve the various properties such as compatibility with the recording medium, storage stability and image storability.

<Method for Manufacturing Liquid Developer>

A known method such as the coacervation method described below or a wet pulverization method, mini-emulsion polymerization method or the like may be used as the method for manufacturing the liquid developer.

The liquid developer manufacturing method of the invention is a method for manufacturing a liquid developer containing:

an insulating liquid and

a toner particle that contains:
a polyamine compound, and
a binder resin and a colorant having an acidic group, or a colorant and a binder resin having an acidic group,
   and comprises,

a step 1 of preparing a mixture containing:
an insulating liquid,

a binder resin and a colorant having an acidic group, or a colorant and a binder resin having an acidic group,

the polyamine compound, and

a solvent, and

a step 2 of removing the solvent from the mixture, wherein the binder resin does not dissolve in the insulating liquid but dissolves in the solvent.

The mixture in the step 1 also preferably contains a toner particle dispersant that dissolves in both the insulating liquid and the solvent, and a colorant dispersant that does not dissolve in the insulating liquid but dissolves in the solvent.

The step 1 also preferably includes a step of dissolving or dispersing the binder resin and the colorant having an acidic group or the colorant and the binder resin having an acidic group, the polyamine compound, and a toner dispersant and colorant dispersant as necessary in a solvent to prepare a solution or dispersion, and a step of mixing this solution or dispersion with the insulating liquid to precipitate the binder resin or binder resin having an acidic group that is contained in a dissolved state in the solution or dispersion.

Specific manufacturing methods are described below, but the present invention is not limited thereby.

<Step 1>

In the step 1, a solution or dispersion may be prepared by dissolving or dispersing the binder resin and the colorant having an acidic group or the colorant and the binder resin having an acidic group, the polyamine compound, and a toner dispersant and colorant dispersant as necessary in a solvent.

The step of preparing the solution or dispersion may also include the following steps.

The colorant or colorant having an acidic group (hereunder sometimes called simply the colorant), the colorant dispersant and the polyamine compound are mixed with a solvent, and the materials are dissolved or dispersed with a media type disperser such as an attritor, ball mill or sand mill or a non-media type disperser such as a high-speed mixer or high-speed homogenizer to obtain a first solution or dispersion (step 1-1).

The binder resin or binder resin having an acidic group (hereunder sometimes called simply the binder resin) and a toner particle dispersant are added to the first solution or dispersion, and the materials are dissolved or dispersed with a media type disperser such as an attritor, ball mill or sand mill or a non-media type disperser such as a high-speed mixer or high-speed homogenizer to obtain a second solution or dispersion (step 1-2).

Saying that the “binder resin does not dissolve in the insulating liquid but dissolves in the solvent” may mean that the amount of the binder resin that dissolves in the insulating liquid at 25° C. is not more than 1 mass part per 100 mass parts of the insulating liquid, while the amount of the dispersant that dissolves in the solvent at 25° C. is more than 10 mass parts per 100 mass parts of the solvent.

The amount (total amount) of the solvent added to the binder resin is preferably from 67 to 2,000 mass parts or more preferably from 133 to 1,000 mass parts per 100 mass parts of the binder resin. If the added amount of the solvent is within this range, productivity is good, and it is easy to form the desired toner shape.

The added amount of the binder resin relative to the colorant is preferably from 10 to 2,000 mass parts or more preferably from 20 to 200 mass parts per 100 mass parts of the colorant. If the added amount of the colorant is within this range, it is easy to form high-density images, and form a toner particle with the desired particle shape.

Next, the second solution or dispersion obtained in the step (1-2) above is mixed with the insulating liquid, to precipitate the binder resin contained in a dissolved state in the second solution or dispersion, and obtain a liquid mixture (this is also called the mixing step below). In this case, the insulating liquid is preferably added to the second solution or dispersion.

As discussed above, the binder resin is preferably precipitated (that is, two-phase separated) in the mixing step. Therefore, it is desirable to mix in the insulating liquid in an amount that causes two-phase separation of the binder resin in the mixing step.

Two-phase separation of the binder resin means that the binder resin contained in a dissolved state in the second solution or dispersion has been precipitated, and binder resin particle formation could be confirmed.

When mixing in the insulating liquid in this mixing step, it is desirable to apply high shear force. This shear force can be set appropriately according to the desired particle diameter. A non-media type disperser such as a high-speed mixer or high-speed homogenizer is preferred as a high-speed shearing device capable of applying high shear force.

These devices vary in terms of capacity, rotational speed, model and the like, and a suitable device can be used according to the production mode. Using a homogenizer, the rotational speed is preferably from 500 to 30,000 rpm, or more preferably from 13,000 to 28,000 rpm.

The mixing step is also preferably performed at or above the freezing points and at or below the boiling points of the solvent and insulating liquid. Specifically, it is preferably performed at from 0° C. to 60° C.

The mass mixing ratio of the insulating liquid and solvent in the step 1 [(mass of insulating liquid/(mass of insulating liquid+mass of solvent)] depends on the combination of insulating liquid, solvent, colorant dispersant, toner particle dispersant and polyamine compound, but is preferably from 0.2 to 0.8, or more preferably from 0.3 to 0.6.

If the mass mixing ratio is within this range, it is easier to improve the dispersion stability of the toner particle because the solids concentration is appropriate after solvent removal, and it is possible to reduce the film thickness during development.

<Step 2>

Step 2 is a step of removing the solvent from the mixture obtained in the step 1.

A method such as evaporation is suitable for removing the solvent. The conditions for removal are preferably 1 to 200 kPa of pressure (low-pressure conditions) at 0° C. to 60° C.

In the toner particle manufactured through this step, the carbon black or the like is more easily encapsulated inside the particle than in a toner particle manufactured by another method such as wet pulverization, and good storage stability is obtained because the carbon black or the like does not directly contact the cationically polymerizable liquid monomer or photopolymerization initiator.

<Solvent>

The solvent may be one having a larger SP value that the insulating liquid. The SP value of the solvent is preferably from 8.5 to 15.0, or more preferably from 9.0 to 13.0. A resin that dissolves in a solvent with an SP value of from 8.5 to 15.0 may be used as the binder resin.

Since the solvent is removed from the mixture by distillation, it is preferably a low-boiling-point solvent. The boiling point of the solvent is preferably not more than 150° C., or more preferably not more than 100° C.

Examples of the solvent include toluene (SP 8.9, boiling point 110° C.), chloroform (SP 9.2, boiling point 61° C.), methyl ethyl ketone (SP 9.3, boiling point 80° C.), tetrahydrofuran (SP 9.5, boiling point 66° C.), acetone (SP 9.8, boiling point 56° C.), ethanol (SP 13, boiling point 78° C.) and methanol (SP 14, boiling point 65° C.).

<Liquid Developer Preparation Step>

A liquid developer preparation step may be included after the step 2. In the liquid developer preparation step, a charge control agent, photopolymerization initiator and other additives may be added as necessary to the toner particle dispersion obtained in step 2 to prepare a liquid developer. The methods for adding the charge control agent, photopolymerization initiator and other additives are not particularly limited, and heating and stirring may be performed as appropriate according to the type of additive.

Other unit operations such as washing of the toner particle may also be added appropriately to this step.

<Toner Particle Dispersant>

The toner particle dispersant promotes toner particle formation and stably disperses the toner particle in the insulating liquid.

The toner particle dispersant is one that dissolves in both the insulating liquid and the solvent.

“Dissolves in both the insulating liquid and the solvent” may mean that the amount of the toner particle dispersant that dissolves in the insulating liquid at 25° C. is more than 10 mass parts per 100 mass parts of the insulating liquid, and that the amount of the toner particle dispersant that dissolves in the solvent at 25° C. is more than 10 mass parts per 100 mass parts of the solvent.

In the coacervation method, as discussed above, a toner particle is manufactured by using a phenomenon in which a polymer dissolved in a good solvent undergoes phase separation when a weak solvent is added.

When manufacturing the liquid developer by the coacervation method, the dispersion stability of the toner particle in the insulating liquid can be improved by dispersing the toner particle in the insulating liquid in the presence of a toner particle dispersant. The charge characteristics and electrophoretic properties of the toner particle can also be improved.

The type of toner particle dispersant is not particularly limited as long as can dissolve in the insulating liquid and solvent and stably disperse the toner particle, and it may be selected from known toner particle dispersants.

For example, preferably the toner particle dispersant contains a monomer unit represented by formula (1) below and a monomer unit represented by formula (2) below, and the amine value derived from primary amino groups contained in the monomer unit represented by formula (1) below is at least 50% of the amine value of the toner particle dispersant.

K (1)

where K represents a monomer unit containing an amino group.

Q (2)

where Q represents a monomer unit containing an optionally substituted alkyl group having 6 or more carbon atoms, an optionally substituted cycloalkyl group having 6 or more carbon atoms, an optionally substituted alkylene group having 6 or more carbon atoms, or an optionally substituted cycloalkylene group having 6 or more carbon atoms.

The optionally substituted alkyl group having 6 or more carbon atoms or optionally substituted cycloalkyl group having 6 or more carbon atoms of Q in formula (2) is an alkyl or cycloalkyl group represented by the straight-chain —CₙH₂ₙ₊₁ or the cyclic-CₙH₂ₙ₋₁, in which the carbon number n is at least 6. Moreover, the optionally substituted alkylene group having 6 or more carbon atoms or optionally substituted cycloalkylene group having 6 or more carbon atoms is an alkylene or cycloalkylene group represented by the straight-chain —CₙH₂ₙ₋₁ or the cyclic —CₙH₂ₙ₋₂-, in which the carbon number n is at least 6.

From the standpoint of affinity with the insulating liquid, the carbon number n is preferably at least 12. The upper limit of n is preferably 30, or more preferably 22. At least one hydrogen atom may also be substituted in the alkyl group, cycloalkyl group, alkylene group or cycloalkylene group.

The optional substituent of the alkyl group, cycloalkyl group, alkylene group or cycloalkylene group of Q is not particularly limited, and examples include alkyl and alkoxy groups, halogen atoms, and amino, hydroxy, carboxy, carboxylic acid ester and carboxylic acid amide groups and the like.

The amine value of the toner particle dispersant is preferably from 40 mgKOH/g to 200 mgKOH/g.

The molecular weight of the toner particle dispersant depends on the numbers of the monomer unit represented by formula (1) and the monomer unit represented by formula (2) constituting the dispersant, but is preferably a number-average molecular weight of from 1,000 to 400,000. The dispersion stability of the toner particle will be good if the number-average molecular weight is within this range.

Given 1 as the number of monomer units represented by formula (1) in the toner particle dispersant, the average number of monomer units represented by formula (2) in the toner particle dispersant is preferably from 0.01 to 100, or more preferably from 0.1 to 10.

If the average number of monomer units represented by formula (2) is at least 0.01, affinity with the insulating liquid is adequate, while if it is not more than 100 the dispersion stability of the toner particle is improved.

The content of the toner particle dispersant is preferably from 0.5 to 20 mass parts per 100 mass parts of the binder resin.

Within this range, the dispersibility of the toner particle is further improved, and the toner particle can maintain good fixing strength without the toner particle dispersant capturing the insulating liquid.

One or two or more kinds of the toner particle dispersant may be used.

Commercial examples of the toner particle dispersant include Ajisper PB817 (reaction product of a polyallyalmine and a self-condensate of 12-hydroxystearic acid; manufactured by Ajinomoto Fine Techno Co., Ltd.), Solsperse 3000, 11200 and 13940 (reaction product of polyethylene polyamine and a self-condensate of 12-hydroxystearic acid) and 11200, 17000 and 18000 (Lubrizol Japan), Antaron V-216, V-220 and WP-660 (ISP Japan), Lipidure-S (NOF), RAM Resin 3000 and 4000 (Osaka Organic Chemistry Industry, Ltd.) and the like.

In a preferred embodiment, the toner particle dispersant is the reaction product of a polyallyalmine and a self-condensate of 12-hydroxystearic acid. The adsorbing group of the toner particle dispersant can be adsorbed strongly onto the toner particle because the polyallylamine has a high cation density, and the dispersing groups of the toner particle dispersant can provide better dispersing performance because the self-condensate of 12-hydroxystearic acid has high affinity for the insulating liquid.

Moreover, Ajisper PB817 and the like fulfill the condition that the amine value derived from primary amino groups contained in the monomer unit represented by formula (1) be at least 50% of the amine value of the toner particle dispersant. On the other hand, the Solsperse 13940 does not fulfill this condition because the amino groups obtained from the reaction product of polyethylene polyamine and a self-condensate of 12-hydroxystearic acid are all secondary or tertiary amino groups apart from the terminal amino groups, and thus the amine value derived from primary amino groups is not more than 50% of the amine value of the Solsperse 13940.

<Colorant Dispersant>

The colorant dispersant does not dissolve in the insulating liquid, but dissolves in the solvent.

“Does not dissolve in the insulating liquid, but dissolves in the solvent” may mean that the amount of the colorant dispersant that dissolves in the insulating liquid at 25° C. is not more than 10 mass parts per 100 mass parts of the insulating liquid, and the amount that dissolves in the solvent at 25° C. is more than 10 mass parts per 100 mass parts of the solvent.

Examples of the colorant dispersant include carboxylic acid esters containing hydroxyl groups, salts of long-chain polyaminoamides and high-molecular-weight acid esters, salts of high-molecular-weight polycarboxylic acids, high-molecular-weight unsaturated acid esters, high-molecular-weight copolymers, modified polyacrylates, aliphatic polyvalent carboxylic acids, naphthalenesulfonic acid formalin condensate, polyoxyethylene alkyl phosphate ester, pigment derivatives and the like. A commercial high-molecular-weight dispersant such as the Solsperse series (Lubrizol Japan) may also be used. The Vylon UR series (Toyobo) may also be used.

Synergists corresponding to the various pigments may also be used as colorant dispersion aids.

The added amount of these colorant dispersants and colorant dispersion aids is preferably from 1 to 50 mass parts per 100 mass parts of the colorant.

A dispersion method suited to the toner particle manufacturing method may be used for dispersing the colorant in the toner particle. Devices that can be used as dispersion means include ball mills, sand mills, attritors, roll mills, jet mills, homogenizers, paint shakers, kneaders, agitators, Henschel mixers, colloid mills, ultrasound homogenizers, pearl mills, wet jet mills and the like.

<Toner Particle>

To obtain high-definition images, the 50% particle diameter (D50) of the toner particle based on volume is preferably from 0.05 μm to 5.0 μm, or more preferably from 0.05 μm to 1.2 μm, or still more preferably from 0.05 μm to 1.0

If the 50% particle diameter (D50) of the toner particle based on volume is within this range, the toner images formed with the liquid developer can have sufficiently high resolution and image density, and the film thickness of the toner image can be sufficiently thin even using a recording system that leaves a residue of the insulating liquid on the recording medium.

In this Description, the “average particle diameter” is the volume-based average particle diameter.

The particle size distribution of the toner particle is preferably from 1.0 to 5.0, or more preferably from 1.1 to 4.0, or still more preferably from 1.2 to 3.0.

In the present invention, the particle size distribution is the ratio (D95/D50) of the volume-based 95% particle diameter (D95) to the volume-based 50% particle diameter (D50).

If the particle size distribution of the toner particle is within this range, the change in viscosity is small when the concentration of the liquid developer changes.

The toner particle concentration in the liquid developer may be adjusted at will according to the image-forming apparatus used, but may be about from 1 mass % to 70 mass %.

<Properties of Liquid Developer>

The liquid developer is preferably prepared with physical property values such as those described below.

To obtain a toner particle with a suitable electrophoretic speed, the viscosity of the liquid developer is preferably 0.5 to 10 mPa·s at 25° C. if the toner particle concentration is 2 mass %. The volume resistivity of the liquid developer is preferably 1×10⁹ Ω·cm to 1×10¹³ Ω·cm from the standpoint of not lowering the potential of the electrostatic latent image.

<Image-Forming Apparatus>

The liquid developer can be used favorable in a common electrophotographic image-forming apparatus.

In the case of a curable liquid developer using a polymerizable liquid monomer for the insulating liquid, the image is fixed by exposing the curable liquid developer to UV rays to cure it immediately after it has been transferred to the recording medium.

The light source for the UV rays may be a mercury lamp, metal halide lamp, excimer laser, UV laser, cold-cathode tube, hot-cathode tube, black light, LED (light-emitting diode) or the like, and a belt-shaped metal halide lamp, cold-cathode tube, hot-cathode tube, mercury lamp, black light or LED is preferred. The UV radiation dose is preferably 0.1 to 1000 mJ/cm².

### EXAMPLES

The present invention is explained in detail below by examples, but the present invention is not limited to these examples. Unless otherwise specified, parts and percentages below represents mass parts and mass percentages.

<Method for Measuring Acid Value>

The basic operations for measuring acid value are based on JIS K-0070. Specifically, the following methods are followed.

1) 0.5 to 2.0 g of sample are weighed exactly, and its mass given as M1 (g).

2) The sample is placed in a 50 mL beaker, and dissolved by addition of 25 mL of a tetrahydrofuran/ethanol (2/1) mixture.

3) This is titrated with a 0.1 mol/L ethanol solution of KOH, using a potentiometric titration apparatus (COM-2500 automatic titration measurement apparatus, Hiranuma Sangyo).

4) 51 (mL) is given as the amount of the KOH solution used here. A blank sample is measured at the same time, and the amount of KOH used in that case is given as B1 (mL).

5) The acid value is calculated by the following formula, with f being the factor of the KOH solution.

$$Acid value [ mg KOH \text{/} g ] = \frac{( S 1 - B 1 ) \times f \times 5.61}{M 1}$$

<Method for Measuring Amine Value>

The basic procedures for measuring amine value are based on ASTM D2074.

Specifically, the following methods are used.

1) 0.5 to 2.0 g of sample is weighed precisely, and its mass given as M2 (g).

2) The sample is placed in a 50 mL beaker, and dissolved by addition of 25 mL of a tetrahydrofuran/ethanol (3/1) mixture.

3) This is titrated with an 0.1 mol/L ethanol solution of HCl, using a potentiometric titration apparatus (COM-2500 automatic titration measurement apparatus, Hiranuma Sangyo).

4) The amount of HCl solution used is given as S2 (mL). A blank is measured in the same way, and the amount of HCl used in that case is given as B2 (mL).

5) The acid value is calculated by the following formula, with f being the factor of the HCl solution.

$$Amine value [ mg KOH \text{/} g ] = \frac{( S 2 - B 2 ) \times f \times 5.61}{M 2}$$

<Methods for Measuring Weight-Average Molecular Weight (Mw) and Number-Average Molecular Weight (Mn)>

The molecular weights of the polymer and the like were calculated by gel permeation chromatography (GPC) using polystyrene conversion.

The sample was added to the following eluent to a sample concentration of 1.0 mass % and left for 24 hours at room temperature to dissolve, and the resulting solution was filtered through a solvent-resistant membrane filter with a pore diameter of 0.20 μm to obtain a sample solution that was then measured under the following conditions.

Apparatus: HLC-8220GPC high-speed GPC unit (Tosoh Corporation)
Columns: LF-804 (2-coupled)

### Eluent: Tetrahydrofuran (THF)

Flow rate: 1.0 mL/min
Oven temperature: 40° C.
Sample injection volume: 0.025 mL

A molecular weight calibration curve prepared using standard polystyrene resin [product name: TSK standard polystyrene F-850, F-450, F-288, F-128, F-80, F-40, F-20, F-10, F-4, F-2, F-1, A-5000, A-2500, A-1000, A-500, Tosoh Corporation] is used for calculating the molecular weights of the samples.

<Determining Structure of Compound>

A structure of a compound was determined by the following methods.

¹H-NMR and ¹³C-NMR spectrum measurement was performed using a IEOL ECA-400 (400 MHz).

Measurement was performed at 25° C. in a deuterated solvent containing tetrahydrofuran as an internal standard substance. The chemical shift value was shown as a ppm shift value (6 value) given 0 as the value of the internal standard substance tetrahydrofuran.

### Example A1

### (Manufacturing Example of Toner Particle A1)

10.0 parts of NIPex 35 (carbon black, pH 9.0, Orion Engineered Carbons, Inc.), 0.2 parts of PAA-25 (polyallylamine; Nittobo Medical Co., Ltd.), 7.5 parts of Vylon UR-4800 as a colorant dispersant (urethane modified polyester resin, Toyobo) and 82.3 parts of a solvent (tetrahydrofuran (THF)) were mixed and kneaded for 1 hour in a paint shaker with steel beads 5 mm in diameter to obtain a kneaded product 1.

49.3 parts of the kneaded product 1, 49.3 parts of a 50% THF solution of Diacron FC-1565 (polyester esin with acid value of 6 mgKOH/g, Mitsubishi Rayon Co., Ltd.) and 1.4 parts of a toner particle dispersant (Ajisper PB-817, Ajinomoto Fine Techno) were mixed in a high-speed disperser (manufactured by Primix Corp., T.K. Robomix/T.K. Homo-Disper Model 2.5), and stirred and mixed at 40° C. to obtain a pigment dispersion 1.

The resulting pigment dispersion 1 (100.0 parts) was stirred at high speed (15,000 rpm) with a homogenizer (IKA Ultra. Turrax T50) as 65.0 parts of dodecyl vinyl ether (example compound A-3) were added bit by bit to obtain a mixture 1.

The mixture 1 was transferred to a round-bottomed flask, and the THF was completely distilled off at 50° C. under ultrasound dispersion, to obtain a toner particle dispersion 1 containing a toner particle in an insulating liquid.

(Manufacturing Example of Curable Liquid Developer A1)

The resulting toner particle dispersion 1 (10.0 parts) was centrifuged, the supernatant was removed by decantation, and fresh dodecyl vinyl ether was substituted in the same amount as the removed supernatant to re-disperse the particle.

89.7 parts of butyl ethyl propanediol divinyl ether (example compound A-27) as a cationically polymerizable liquid monomer and 0.3 parts of a photopolymerization initiator (example compound B-26) were then added to obtain a curable liquid developer A1.

(Evaluation of Particle Diameter)

The curable liquid developer was diluted with the same cationically polymerizable liquid monomer, and the number-average particle diameter (Unit: μm, hereunder “particle diameter”) of the toner particle in the curable liquid developer was measured using a Nanotrac 150 (Nikkiso) with a range setting of 0.001 μm to 10 μm, and evaluated according to the following standard.

10: (Particle diameter)<0.7
9: 0.7≤(Particle diameter)<0.9
8: 0.9≤(Particle diameter)<1.1
7: 1.1≤(Particle diameter)<1.3
6: 1.3≤(Particle diameter)<1.5
5: 1.5≤(Particle diameter) 1.7
4: 1.7≤(Particle diameter)<1.9
3: 1.9≤(Particle diameter)<2.1
2: 2.1≤(Particle diameter)<2.3
1: 2.3≤(Particle diameter)

(Evaluating Encapsulation Behavior of Carbon Black)

The carbon black encapsulation behavior of the toner particle in the curable liquid developer was analyzed by the following procedures, and evaluated according to the following standard.

The dried toner particle was worked with a cross-section polisher (SM-09010, JEOL) to prepare a toner particle cross-section.

The resulting toner cross-section was metal coated by ion sputter (E-1030, Hitachi High-Technologies) and observed under a field emission scanning electron microscope (S-4500, Hitachi High-Technologies), and the position, degree of uneven distribution and dispersibility of the carbon black in the toner particle were evaluated.

5: Carbon black entirely enveloped and distributed evenly in particle.
4: Carbon black entirely enveloped but aggregated in particle.
3: Carbon black mostly enveloped in toner particle, but some exposed on particle surface.
2: Carbon black unevenly distributed toward particle surface and exposed.
1: Carbon black not enveloped at all, separated from toner particle.

(Polarity of Toner Particle)

The polarity of the toner particle in the curable liquid developer was evaluated by the following procedures.

A sample diluted with the cationically polymerizable liquid monomer to a toner particle concentration of 1 mass % was held by capillary force between parallel plate electrodes, which are metal electrodes having a thickness of 300 μm and a width of 20 mm and facing each other at a distance of 100 μm. The electrophoretic state with a 100 V potential difference applied between the parallel plate electrodes (field strength 1×10⁶ μm) was photographed with a FASTCAM SA-1 (Photron) camera attached to an optical microscope. The polarity of the toner particle was considered negative when it migrated towards the cathode and positive when it migrated towards the anode. A negative toner particle polarity was judged to be good.

(Evaluation of Storage Stability)

The sample was left standing in a light-shielded environment at 50° C., and the condition of the curable liquid developer was observed visually and evaluated according to the following standard. Solidification was taken as evidence of dark polymerization.

10: Dark polymerization occurs within 150 days or not 1.
9: Dark polymerization occurs within 130 days.
8: Dark polymerization occurs within 110 days.
7: Dark polymerization occurs within 90 days.
6: Dark polymerization occurs within 70 days,
5: Dark polymerization occurs within 50 days.
4: Dark polymerization occurs within 30 days.
3: Dark polymerization occurs within 15 days.
2: Dark polymerization occurs within 7 days.
1: Dark polymerization occurs within 1 day.

(Evaluation of Fixability)

The liquid developer was dripped onto a polyethylene terephthalate film in an environment of 25° C., humidity 50%, and bar coated with a wire bar (No. 6, supplied by Matsuo Sangyo Co., Ltd.) (formed film thickness 13.7).

This was then exposed to light at a wavelength of 365 nm with a high-pressure mercury lamp (lamp output 120 mW/cm²) to form a cured film.

The irradiation light dose was measured at the point at which the film lost its surface tackiness (stickiness) and was completely cured, and evaluated according to the following standard.

10: Not more than 100 mJ/cm²
9: Not more than 150 mJ/cm²
8: Not more than 200 mJ/cm²
7: Not more than 300 mJ/cm²
6: Not more than 400 mJ/cm²
5: Not more than 800 mJ/cm²
4: Not more than 1000 mJ/cm²
3: Not more than 1500 mJ/cm²
2: Not more than 2000 mJ/cm²
1: Not cured

A score of 6 or above is judged to indicate good fixability.

### Examples A2 to A18

Curable liquid developers were obtained as in the Example A1 except that the cationically polymerizable liquid monomers, binder resins, toner particle dispersants, amine compounds, colorants and polymerization initiators shown in Table 1-1 were compounded. Each evaluation was also performed as in Example A1. The results are shown in Table 1-1.

In Example A4, 8.5 parts of NIPex 35 and 1.5 part of ECB-308 (copper phthalocyanine pigment, Dainichiseika used together.

### Example A19

24.1 parts of Diacron FC-1565 (polyester resin with acid value of 6 KOH/g, Mitsubishi Rayon Co., Ltd.), 1.8 parts of Ajisper PB-817 (Ajinornoto Fine Techno) as a toner particle dispersant and 74.1 parts of dodecyl vinyl ether (example compound A-3) as a cationically polymerizable liquid monomer were loaded into a separable flask, and stirred at 200 rpm with a three-one motor as the temperature was raised to 130° C. over the course of an hour in an oil bath. This was maintained at 1.30° C. for 1 hour, and cooled at a rate of 15° C. per hour to prepare a toner particle precursor. The resulting toner particle precursor was in the form of a white paste.

59.4 parts of the toner particle precursor, 10.0 parts of NIPex 35 (carbon black, pH 9.0, Orion Engineered Carbons), 0.2 parts of PAA-03E (polyallylamine, Nittobo Medical Co., Ltd.) and 30.4 parts of dodecyl vinyl ether (example compound A-3) were loaded into a Classic Line P-6 (planetary bead mill manufactured by Fritsch Co.) together with zirconia, grinding balls having a diameter of 0.5 mm (Tosoh Corporation), and pulverized for 4 hours at room temperature at 200 rpm to obtain a toner particle dispersion 2 (solids 25 mass %). 70.1 parts of butyl ethyl propanediol divinyl ether (example compound A-27) as a cationically polymerizable liquid monomer and 0.3 parts of a photopolymerization initiator (example compound B-26) were then added to 29.6 parts of the toner particle dispersion 2 to obtain a curable liquid developer A19.

### Examples A20 to A41 and. Comparative Examples A1 to A14

Curable liquid developers were obtained as in Example A19 except that the cationically polymerizable liquid monomers, binder resins, toner particle dispersants, amine compounds, colorants and polymerization initiators shown in Tables 1-1 to 1-3 were compounded. Each evaluation was performed as in the Example A1. The results are shown in Tables 1-1 to 1-3. The symbols or names used in Table 1-1, Table 1-2, Table 1-3 and Table 3 represent the following products.

### <Cationically Polymerizable Liquid Monomers>

CEL2021P (Ce oxide CEL 2021 P, epoxide, manufactured by Daicel) OXT-221 (Aron oxetane OXT-221, oxetane, manufactured by Toagosei Co., Ltd.)

<Binder Resins>

FC-1565 (Diacron FC-1565, polyester resin with acid value of 6 mgKOH/g, Mitsubishi Rayon Co., Ltd.)
Vylon 220 (low-acid-value polyester resin, acid value less than 2 mgKOH/g, Toyobo)

<Toner Particle Dispersants>

Ajisper PB-817 (reaction product of a polyallyalmine and a self-condensate of 12-hydroxystearic acid, Ajinomoto Fine Techno)
Solsperse 13940 (reaction product of polyethylene polyamine and a self-condensate of 12-hydroxystearic acid, Lubrizol Japan)
Antaron V-216 (copolymer of vinyl pyrrolidone and hexadecene, ISP Japan)
Lipidure-S (copolymer of 2-methacryloyloxyethyl phosphorylcholine and stearyl methacrylate, NOF)
RAM Resin 4000 (polymer containing carboxybetaine units, Osaka Organic Chemistry Industry, Ltd.)
Solsperse 3000 (acidic polymer dispersant containing carboxyl groups, Lubrizol)

<Amine Compounds>

PAA-25 (polyallylamine, weight-average molecular weight (Mw) 25,000, Nittobo Medical Co., Ltd.)
PAA-15C (polyallylamine, Mw: 15,000, Nittobo Medical Co., Ltd.)
PAA-08 (polyallylamine, Mw: 8,000, Nittobo Medical Co., Ltd.)
PAA-05 (polyallylamine, Mw: 5,000, Nittobo Medical Co., Ltd.)
PAA-03E (polyallylamine, Mw: 3,000, Nittobo Medical Co., Ltd.)
PAA-01 (polyallylamine, Mw: 1,600, Nittobo Medical Co., Ltd.)
SP-018 (polyethylenimine compound, Mw: 1,800, Nippon Shokubai Co., Ltd.)
SP-200 (polyethylenimine compound, Mw: 10,000, Nippon Shokubai Co., Ltd.)
Lupasol FG (polyethylenimine compound, Mw: 800, BASF)
Lupasol WF (polyethylenimine compound, Mw: 25,000, BASF)
PVAM-0595B (polyvinylamine compound, Mw: 70,000, Mitsubishi Rayon Co., Ltd.)

### Polyaniline (Mw: 20,000, Sigma-Aldrich)

### Polypyrrole (Mw: 80,000, Sigma-Aldrich)

Aniline (molecular weight: 93, Sigma-Aldrich)
Pyrrole (molecular weight: 67, Sigma-Aldrich)
Triethylamine (molecular weight: 101, Sigma-Aldrich)
Ethylenediamine (molecular weight: 60, Sigma-Aldrich)

<Colorants>

NIPex 35 (carbon black, pH 9.0, Orion Engineered Carbons)
#85 (carbon black, pH 7.5, Mitsubishi Chemical)
MA7 (carbon black, pH 3.0, Mitsubishi Chemical)
MA77 (carbon black, pH 2.5, Mitsubishi Chemical)

<Polymerization Initiators>

CPI-110P (triarylsulfonium salt type cationic photopolymerization initiator, manufactured by San-Apro Ltd.)
WPI-113 (diphenyliodonium salt type cationic photopolymerization initiator, Wako Pure Chemical)

[Binder Resin Manufacturing Examples]

### <Manufacturing Examples of Binder Resins (P-1) and (P-2)>

A polyester resin (P-1) and styrene-acrylic resin (P-2) with the compositions shown in Table 2 were synthesized by known methods, and the physical properties of both are shown in Table 2. The compositions in the table are described as molar ratios.

<Manufacturing Examples of Binder Resins (P-3) to (P-7)>

Polyester resins (P-3) to (P-7) were synthesized with the compositions shown in Table 2, and finally trimellitic anhydride was added to obtain the acid values shown in Table 2. The physical properties of each are shown in Table 2. The compositions in the table are described as molar ratios.

<Manufacturing example of 12-hydroxystearic acid self-condensate>30.0 parts of xylene (Junsei Chemical), 300.0 parts of 12-hydroxystearic acid (Junsei Chemical) and 0.1 part of tetrabutyl titanate (Tokyo Kasei) were loaded into a reaction flask equipped with a thermometer, a stirrer, a nitrogen inlet, a reflux tube and a moisture separator, and heated to 160° C. over the course of 4 hours in a nitrogen flow. This was then further heated for 4 hours at 160° C. (at which time the acid value was about 20 mg KOH/g), and the xylene was distilled off at 160° C. This was then cooled to room temperature, the water produced during the heating reaction was separated from the xylene in the distillate, and this xylene was returned to the reaction solution.

This reaction solution is called the 12-hydroxystearic acid self-condensate hereunder. The polyester contained in the 12-hydroxystearic acid self-condensate had a number-average molecular weight of 2550 and an acid value of 22.0 mgKOH/g. Incidentally, a polyester prepared in this way can be used as a raw synthesis material of a polyamine derivative without removing the solvent (xylene).

[Manufacturing Example of Toner Particle Dispersant]

### <Manufacturing Example of Toner Particle Dispersant (D-1)>

A mixture 25.0 parts of xylene and 70 parts of a 10% aqueous polyallylamine aqueous solution (PAA-08, Nittobo Medical Co., Ltd., Mw: 8,000) was stirred at 160° C. in a reaction flask equipped with a thermometer, a stirrer, a nitrogen inlet and a reflux tube, the water was distilled off with a separator, and the xylene was returned to the reaction solution as a xylene solution of 70 parts of 12-hydroxystearic acid self-condensate were added and reacted for 2 hours at 160° C. to obtain a toner particle dispersant (D-1) (amine value: 70.0 mgKOH/g).

TABLE 1-1

| Example | Cationically | Binder resin | | Toner | Amine compound | | Carbon black | | | Pigment | | | | | | Toner | | |
|---|---|---|---|---|---|---|---|---|---|---|---|---|---|---|---|---|---|---|
| Comparative | polymerizable | | Acid | particle | | Ratio | | | Ratio | | Ratio | Polymerization | Manufacturing | Particle | | particle | Storage | |
| Example No. | liquid monomer | Type | value | dispersant | Type | A | Type | pH | B | Type | B | initiator | method | diameter | Encapsulation | polarity | stability | Fixability |
| A1 | (A-3) | FC- | 6 | Ajisper | PAA- | 2 | NIPex | 9.0 | 100% | — | 0% | (B-26) | Coacervation | 10 | 5 | Negative | 9 | 10 |
| | (A-27) | 1565 | | PB817 | 25 | | 35 | | | | | | | | | | | |
| A2 | (A-3) | FC- | 6 | Ajisper | PAA- | 2 | NIPex | 9.0 | 100% | — | 0% | (B-23) | Coacervation | 10 | 5 | Negative | 9 | 10 |
| | (A-27) | 1565 | | PB817 | 25 | | 35 | | | | | | | | | | | |
| A3 | (A-3) | FC- | 6 | Ajisper | PAA- | 2 | NIPex | 9.0 | 100% | — | 0% | (B-6) | Coacervation | 10 | 5 | Negative | 9 | 9 |
| | (A-27) | 1565 | | PB817 | 25 | | 35 | | | | | | | | | | | |
| A4 | (A-3) | FC- | 6 | Ajisper | PAA- | 2 | NIPex | 9.0 | 85% | ECB- | 15% | (B-6) | Coacervation | 10 | 5 | Negative | 9 | 9 |
| | (A-27) | 1565 | | PB817 | 25 | | 35 | | | 308 | | | | | | | | |
| A5 | (A-27) | FC- | 6 | Ajisper | PAA- | 2 | NIPex | 9.0 | 100% | — | 0% | (B-26) | Coacervation | 10 | 5 | Negative | 9 | 10 |
| | | 1565 | | PB817 | 25 | | 35 | | | | | | | | | | | |
| A6 | (A-27) | FC- | 6 | Ajisper | PAA- | 2 | NIPex | 9.0 | 100% | — | 0% | (B-23) | Coacervation | 10 | 5 | Negative | 9 | 10 |
| | | 1565 | | PB817 | 25 | | 35 | | | | | | | | | | | |
| A7 | (A-27) | FC- | 6 | Ajisper | PAA- | 2 | NIPex | 9.0 | 100% | — | 0% | (B-6) | Coacervation | 10 | 5 | Negative | 9 | 9 |
| | | 1565 | | PB817 | 25 | | 35 | | | | | | | | | | | |
| A8 | (A-26) | FC- | 6 | Ajisper | PAA- | 2 | NIPex | 9.0 | 100% | — | 0% | (B-26) | Coacervation | 10 | 5 | Negative | 9 | 10 |
| | | 1565 | | PB817 | 25 | | 35 | | | | | | | | | | | |
| A9 | (A-3) | FC- | 6 | Ajisper | PAA- | 2 | NIPex | 9.0 | 100% | — | 0% | (B-26) | Coacervation | 10 | 5 | Negative | 9 | 10 |
| | (A-27) | 1565 | | PB817 | 15C | | 35 | | | | | | | | | | | |
| A10 | (A-3) | FC- | 6 | Ajisper | PAA- | 2 | NIPex | 9.0 | 100% | — | 0% | (B-26) | Coacervation | 10 | 5 | Negative | 9 | 10 |
| | (A-27) | 1565 | | PB817 | 08 | | 35 | | | | | | | | | | | |
| A11 | (A-3) | FC- | 6 | Ajisper | PAA- | 2 | NIPex | 9.0 | 100% | — | 0% | (B-26) | Coacervation | 10 | 5 | Negative | 9 | 10 |
| | (A-27) | 1565 | | PB817 | 05 | | 35 | | | | | | | | | | | |
| A12 | (A-3) | FC- | 6 | Ajisper | PAA- | 2 | NIPex | 9.0 | 100% | — | 0% | (B-26) | Coacervation | 10 | 5 | Negative | 10 | 10 |
| | (A-27) | 1565 | | PB817 | 03E | | 35 | | | | | | | | | | | |
| A13 | (A-3) | FC- | 6 | Ajisper | PAA- | 2 | NIPex | 9.0 | 100% | — | 0% | (B-26) | Coacervation | 10 | 5 | Negative | 9 | 10 |
| | (A-27) | 1565 | | PB817 | 01 | | 35 | | | | | | | | | | | |
| A14 | (A-31) | P-3 | 15 | (D-1) | PAA- | 2 | NIPex | 9.0 | 100% | — | 0% | (B-26) | Coacervation | 10 | 5 | Negative | 10 | 10 |
| | | | | | 03E | | 35 | | | | | | | | | | | |
| A15 | (A-31) | P-4 | 12 | (D-1) | PAA- | 2 | NIPex | 9.0 | 100% | — | 0% | (B-26) | Coacervation | 10 | 5 | Negative | 10 | 10 |
| | | | | | 03E | | 35 | | | | | | | | | | | |
| A16 | (A-31) | P-5 | 11 | (D-1) | PAA- | 2 | NIPex | 9.0 | 100% | — | 0% | (B-26) | Coacervation | 10 | 5 | Negative | 10 | 10 |
| | | | | | 03E | | 35 | | | | | | | | | | | |
| A17 | (A-31) | P-6 | 10 | (D-1) | PAA- | 2 | NIPex | 9.0 | 100% | — | 0% | (B-26) | Coacervation | 10 | 5 | Negative | 10 | 10 |
| | | | | | 03E | | 35 | | | | | | | | | | | |
| A18 | (A-31) | P-7 | 18 | (D-1) | PAA- | 2 | NIPex | 9.0 | 100% | — | 0% | (B-26) | Coacervation | 10 | 5 | Negative | 10 | 10 |
| | | | | | 03E | | 35 | | | | | | | | | | | |
| A19 | (A-3) | FC- | 6 | Ajisper | PAA- | 2 | NIPex | 9.0 | 100% | — | 0% | (B-26) | Wet | 10 | 4 | Negative | 9 | 10 |
| | (A-27) | 1565 | | PB817 | 03E | | 35 | | | | | | pulverization | | | | | |
| A20 | (A-3) | FC- | 6 | Ajisper | PAA- | 2 | #85 | 7.5 | 100% | — | 0% | (B-26) | Wet | 10 | 4 | Negative | 8 | 10 |
| | (A-27) | 1565 | | PB817 | 03E | | | | | | | | pulverization | | | | | |
| A21 | (A-3) | FC- | 6 | Ajisper | PAA- | 2 | MA7 | 3.0 | 100% | — | 0% | (B-26) | Wet | 10 | 4 | Negative | 8 | 10 |
| | (A-37) | 1565 | | PB817 | 03E | | | | | | | | pulverization | | | | | |

TABLE 1-2

| Example | Cationically | | | | Amine | | | | | | | | | | | | | |
|---|---|---|---|---|---|---|---|---|---|---|---|---|---|---|---|---|---|---|
| Comparative | polymerizable | Binder resin | | Toner | compound | | Carbon black | | | Pigment | | | | | | Toner | | |
| Example | liquid | | Acid | particle | | Ratio | | | Ratio | | Ratio | Polymerization | Manufacturing | Particle | | particle | Storage | |
| No. | monomer | Type | value | dispersant | Type | A | Type | pH | B | Type | B | initiator | method | diameter | Encapsulation | polarity | stability | Fixability |
| A22 | (A-3) | FC- | 6 | Ajisper | PAA- | 2 | MA77 | 2.5 | 100% | — | 0% | (B-26) | Wet | 10 | 4 | Negative | 8 | 10 |
| | (A-27) | 1565 | | PB817 | 03E | | | | | | | | pulverization | | | | | |
| A23 | (A-3) | FC- | 6 | Solsperse | PAA- | 2 | MA77 | 2.5 | 100% | — | 0% | (B-26) | Wet | 9 | 4 | Negative | 8 | 10 |
| | (A-27) | 1565 | | 13940 | 03E | | | | | | | | pulverization | | | | | |
| A24 | (A-3) | FC- | 6 | Antaron | PAA- | 2 | MA77 | 2.5 | 100% | — | 0% | (B-26) | Wet | 9 | 4 | Negative | 8 | 10 |
| | (A-27) | 1565 | | V-216 | 03E | | | | | | | | pulverization | | | | | |
| A25 | (A-3) | FC- | 6 | Lipidure-S | PAA- | 2 | MA77 | 2.5 | 100% | — | 0% | (B-26) | Wet | 8 | 4 | Negative | 8 | 10 |
| | (A-27) | 1565 | | | 03E | | | | | | | | pulverization | | | | | |
| A26 | (A-3) | FC- | 6 | RAM | PAA- | 2 | MA77 | 2.5 | 100% | — | 0% | (B-26) | Wet | 8 | 4 | Negative | 8 | 10 |
| | (A-27) | 1565 | | Resin-4000 | 03E | | | | | | | | pulverization | | | | | |
| A27 | (A-3) | FC- | 6 | Solsperse | PAA- | 2 | MA77 | 2.5 | 100% | — | 0% | (B-26) | Wet | 8 | 4 | Negative | 8 | 10 |
| | (A-27) | 1565 | | 3000 | 03E | | | | | | | | pulverization | | | | | |
| A28 | (A-3) | Vylon | <2 | Lipidure-S | PAA- | 2 | MA77 | 2.5 | 100% | — | 0% | (B-26) | Wet | 7 | 4 | Negative | 8 | 10 |
| | (A-27) | 220 | | | 03E | | | | | | | | pulverization | | | | | |
| A29 | CEL | Vylon | <2 | Lipidure-S | PAA- | 2 | MA77 | 2.5 | 100% | — | 0% | (B-26) | Wet | 7 | 4 | Negative | 8 | 9 |
| | 2021P | 220 | | | 03E | | | | | | | | pulverization | | | | | |
| A30 | OXT-221 | Vylon | <2 | Lipidure-S | PAA- | 2 | MA77 | 2.5 | 100% | — | 00/ | (B-26) | Wet | 7 | 4 | Negative | 8 | 9 |
| | | 220 | | | 03E | | | | | | | | pulverization | | | | | |
| A31 | CEL | Vylon | <2 | Lipidure-S | SP-018 | 2 | MA77 | 2.5 | 100% | — | 0% | (B-26) | Wet | 7 | 4 | Negative | 8 | 8 |
| | 2021P | 220 | | | | | | | | | | | pulverization | | | | | |
| A32 | CEL | Vylon | <2 | Lipidure-S | SP-200 | 2 | MA77 | 2.5 | 100% | — | 0% | (B-26) | Wet | 7 | 3 | Negative | 8 | 8 |
| | 2021P | 220 | | | | | | | | | | | pulverization | | | | | |
| A33 | CEL | Vylon | <2 | Lipidure-S | Lupasol | 2 | MA77 | 25 | 100% | — | 0% | (B-26) | Wet | 7 | 4 | Negative | 8 | 8 |
| | 2021P | 220 | | | FG | | | | | | | | pulverization | | | | | |
| A34 | CEL | Vylon | <2 | Lipidure-S | Lupasol | 2 | MA77 | 2.5 | 100% | — | 0% | (B-26) | Wet | 7 | 3 | Negative | 8 | 8 |
| | 2021P | 220 | | | WF | | | | | | | | pulverization | | | | | |
| A35 | CEL | Vylon | <2 | Lipidure-S | PVAM- | 2 | MA77 | 2.5 | 100% | — | 0% | (B-26) | Wet | 7 | 3 | Negative | 8 | 8 |
| | 2021P | 220 | | | 0595B | | | | | | | | pulverization | | | | | |
| A36 | CEL | Vylon | <2 | Lipidure-S | Polyaniline | 2 | MA77 | 2.5 | 100% | — | 0% | (B-26) | Wet | 6 | 3 | Negative | 8 | 7 |
| | 2021P | 220 | | | | | | | | | | | pulverization | | | | | |
| A37 | CEL | Vylon | <2 | Lipidure-S | Polypyrrole | 2 | MA77 | 2.5 | 100% | — | 0% | (B-26) | Wet | 6 | 3 | Negative | 8 | 7 |
| | 2021P | 220 | | | | | | | | | | | pulverization | | | | | |
| A38 | CEL | Vylon | <2 | Lipidure-S | Polyaniline | 0.1 | MA77 | 2.5 | 100% | — | 0% | (B-26) | Wet | 6 | 3 | Negative | 7 | 8 |
| | 2021P | 220 | | | | | | | | | | | pulverization | | | | | |
| A39 | CEL | Vylon | <2 | Lipidure-S | Polyaniline | 10 | MA77 | 2.5 | 100% | — | 0% | (B-26) | Wet | 6 | 3 | Negative | 8 | 7 |
| | 2021P | 220 | | | | | | | | | | | pulverization | | | | | |
| A40 | CEL | Vylon | <2 | Lipidure-S | Polyaniline | 0.05 | MA77 | 2.5 | 100% | — | 0% | (B-26) | Wet | 6 | 3 | Negative | 6 | 8 |
| | 2021P | 220 | | | | | | | | | | | pulverization | | | | | |
| A41 | CEL | Vylon | <2 | Lipidure-S | Polyaniline | 15 | MA77 | 2.5 | 100% | — | 0% | (B-26) | Wet | 6 | 3 | Negative | 8 | 6 |
| | 2021P | 220 | | | | | | | | | | | pulverization | | | | | |

TABLE 1-3

| Example | Cationically | | | | Amine | | | | | |
|---|---|---|---|---|---|---|---|---|---|---|
| Comparative | polymerizable | Binder resin | | Toner | compound | | Carbon black | | | |
| Example | liquid | | Acid | particle | | Ratio | | | Ratio | Pigment |
| No. | monomer | Type | value | dispersant | Type | A | Type | pH | B | Type |
| Comparative | CEL | Vylon | <2 | Lipidure- | Not | — | MA77 | 2.5 | 100% | — |
| A1 | 2021P | 220 | | S | added | | | | | |
| Comparative | CEL | Vylon | <2 | Lipidure- | Aniline | 0.05 | MA77 | 2.5 | 100% | — |
| A2 | 2021P | 220 | | S | | | | | | |
| Comparative | CEL | Vylon | <2 | Lipidure- | Pyrrole | 0.05 | MA77 | 2.5 | 100% | — |
| A3 | 2021P | 220 | | S | | | | | | |
| Comparative | CEL | Vylon | <2 | Lipidure- | Triethyl | 0.05 | MA77 | 2.5 | 100% | — |
| A4 | 2021P | 220 | | S | amine | | | | | |
| Comparative | CEL | Vylon | <2 | Lipidure- | Ethylene | 0.05 | MA77 | 2.5 | 100% | — |
| A5 | 2021P | 220 | | S | diamine | | | | | |
| Comparative | CEL | Vylon | <2 | Lipidure- | Not | — | MA77 | 2.5 | 100% | — |
| A6 | 2021P | 220 | | S | added | | | | | |
| Comparative | (A-3) | Vylon | <2 | Lipidure- | Not | — | MA77 | 2.5 | 100% | — |
| A7 | (A-27) | 220 | | S | added | | | | | |
| Comparative | (A-3) | Vylon | <2 | Lipidure- | Aniline | 0.05 | MA77 | 2.5 | 100% | — |
| A8 | (A-27) | 220 | | S | | | | | | |
| Comparative | (A-3) | Vylon | <2 | Lipidure- | Pyrrole | 0.05 | MA77 | 2.5 | 100% | — |
| A9 | (A-27) | 220 | | S | | | | | | |
| Comparative | (A-3) | Vylon | <2 | Lipidure- | Triethyl | 0.05 | MA77 | 2.5 | 100% | — |
| A10 | (A-27) | 220 | | S | amine | | | | | |
| Comparative | (A-3) | Vylon | <2 | Lipidure- | Ethylene | 0.05 | MA77 | 2.5 | 100% | — |
| A11 | (A-27) | 220 | | S | diamine | | | | | |
| Comparative | (A-3) | Vylon | <2 | Lipidure- | Not | — | MA77 | 2.5 | 100% | — |
| A12 | (A-27) | 220 | | S | added | | | | | |
| Comparative | CEL | Vylon | <2 | Lipidure- | Polyaniline | 0.05 | MA77 | 2.5 | 100% | — |
| A13 | 2021P | 220 | | S | | | | | | |
| Comparative | CEL | Vylon | <2 | Lipidure- | Polyaniline | 0.05 | MA77 | 2.5 | 100% | — |
| A14 | 2021P | 220 | | S | | | | | | |

| Example | | | | | | | | |
|---|---|---|---|---|---|---|---|---|
| Comparative | Pigment | | | | | Toner | | |
| Example | Ratio | Polymerization | Manufacturing | Particle | | particle | Storage | |
| No. | B | initiator | method | diameter | Encapsulation | polarity | stability | Fixability |
| Comparative | 0% | (B-26) | Wet | 3 | 2 | Negative | 2 | 7 |
| A1 | | | pulverization | | | | | |
| Comparative | 0% | (B-26) | Wet | 3 | 3 | Negative | 8 | 2 |
| A2 | | | pulverization | | | | | |
| Comparative | 0% | (B-26) | Wet | 3 | 3 | Negative | 8 | 2 |
| A3 | | | pulverization | | | | | |
| Comparative | 0% | (B-26) | Wet | 3 | 3 | Negative | 8 | 2 |
| A4 | | | pulverization | | | | | |
| Comparative | 0% | (B-26) | Wet | 3 | 3 | Negative | 8 | 2 |
| A5 | | | pulverization | | | | | |
| Comparative | 0% | Not | Wet | 3 | 2 | Negative | 10 | 1 |
| A6 | | added | pulverization | | | | | |
| Comparative | 0% | (B-26) | Wet | 3 | 2 | Negative | 2 | 9 |
| A7 | | | pulverization | | | | | |
| Comparative | 0% | (B-26) | Wet | 3 | 3 | Negative | 8 | 3 |
| A8 | | | pulverization | | | | | |
| Comparative | 0% | (B-26) | Wet | 3 | 3 | Negative | 8 | 3 |
| A9 | | | pulverization | | | | | |
| Comparative | 0% | (B-26) | Wet | 3 | 3 | Negative | 8 | 3 |
| A10 | | | pulverization | | | | | |
| Comparative | 0% | (B-26) | Wet | 3 | 3 | Negative | 8 | 3 |
| A11 | | | pulverization | | | | | |
| Comparative | 0% | Not | Wet | 3 | 2 | Negative | 10 | 1 |
| A12 | | added | pulverization | | | | | |
| Comparative | 0% | CPI- | Wet | 6 | 3 | — | — | — |
| A13 | | 110P | pulverization | | | | | |
| Comparative | 0% | WPI- | Wet | 6 | 3 | — | — | — |
| A14 | | 113 | pulverization | | | | | |

In Tables 1-1 to 1-3,

acid values are represented in units of mgKOH/g,

ratio A represents the number of parts of the amine compound per 100 parts of carbon black, and

ratio B represents the content (mass %) in the colorant.

[Manufacturing Examples of Polyamine Compounds]

### <Manufacturing Examples of Polyamine Compounds (Neutralized PAA-03 1) and (Neutralized PAA-03 2)>

1,000 parts of PAA-03 (20%© aqueous solution, polyallylamine, Mw: 3,000, Nittobo Medical Co., Ltd.) and 8.6 parts of HCl aqueous solution (1 mol/L) were mixed in a 2,000 mL beaker, and stirred for 30 minutes to obtain a Neutralized PAA-03 1.

Meanwhile, 1,000 parts of PAA-03 (20% aqueous solution, polyamine, Mw: 3,000, Nittobo Medical Co., Ltd.) and 12.9 parts of HCl aqueous solution (1 mol/L) were mixed in a 2,000 mL, beaker, and stirred for 30 minutes to obtain a Neutralized PAA-03 2.

The analysis results are shown below.

### [Analysis Results for Polyamine Compounds (Neutralized PAA-03 1) and (Neutralized PAA-03 2)]

Amine Value Measurement Results:
(Neutralized PAA-03 1) 473 mgKOH/g
(Neutralized PAA-03 2) 235 mgKOH/g

TABLE 2

| | | | Number-average | Weight-average | |
|---|---|---|---|---|---|
| | | | molecular weight | molecular weight | Acid value |
| | Composition | | (Mn) | (Mw) | [mgKOH/g] |
| P-1 | TPA/TMA/BPA-EO | 37.5/12.5/50 | 2,420 | 18,300 | 21 |
| P-2 | St/Ac | 80/20 | 6,190 | 19,930 | 112 |
| P-3 | TPA/IPA/NPG/EG | 25/25/20/30 | 6,610 | 24,600 | 15 |
| P-4 | TPA/IPA/NPG/EG | 32.5/17.5/20/30 | 6,230 | 21,500 | 12 |
| P-5 | TPA/IPA/NPG/EG | 15/35/20/30 | 6,710 | 25,200 | 11 |
| P-6 | TPA/IPA/NPG/EG | 25/25/32.5/17.5 | 6,680 | 24,300 | 10 |
| P-7 | TPA/IPA/NPG/EG/BPA-PO | 25/25/20/25/5 | 6,550 | 23,700 | 18 |

The abbreviations in Table 2 are defined as follows.

TPA: Terephthalic acid.
TMA: Trimellitic anhydride
BPA-EO: Bisphenol A ethylene oxide 2-mol adduct
BPA-PO: Bisphenol A propylene oxide 2-mol adduct

### St: Styrene

Ac: Acrylic acid
IPA: Isophthalic acid
NPG: Neopentyl glycol
EG: Ethylene glycol

[Manufacturing Example of Liquid Developer B]

### <Manufacturing Example of Pigment Dispersion (Cy-1)>

30 parts of pigment blue 15:3, 47 parts of Vylon UR4800 (Toyobo), 3 parts of PAA-03 (20% aqueous solution, Nittobo Medical Co., Ltd.), 255 parts of tetrahydrofuran and 130 parts of glass beads (diameter of 1 mm) were mixed, dispersed for 3 hours in an Attritor (Nippon Coke &. Engineering), and filtered through a mesh to obtain a kneaded product.

180 parts of the resulting kneaded product, 126 parts of a 50% tetrahydrofuran solution of the binder resin (P-1) and 21 parts of Ajisper PB-817 (called “PB817” in Table 3, Ajinomoto Fine Techno) were stirred at 40° C. in a high-speed disperser (Primix Corp., T.K. Robomix/T.K. Homo-Disper Model 2.5) to obtain a pigment dispersion (Cy-1).

<Manufacturing Examples of Pigment Dispersions (Cy-2) to (Cy-7)==

Pigment dispersions (Cy-2) to (Cy-7) werwere obtained by the same methods as the pigment dispersion (Cy-1) except that the 3 parts of PAA-03 were replaced with 4 parts of PAA-01 (15% aqueous solution, Nittobo Medical Co.; Ltd.), 3 parts of PAA-05 (20% aqueous solution, Nittobo Medical Co., Ltd.), 0.6 parts of SP-003 (98% aqueous solution, polyethylenimine compound, Nippon Shokubai Co., Ltd.), 6 parts of PVAM-0595 B (10% aqueous solution, polyvinylamine compound, Mitsubishi Rayon Co., Ltd.), 3 parts of the Neutralized PAA-03 1 (20% aqueous solution), and 0.6 parts of polyaniline (Sigma-Aldrich) in the manufacturing example of the pigment dispersion (Cy-1).

<Manufacturing Examples of Pigment Dispersions (Cy-8) and (Cy-9)>

Pigment dispersions (Cy-8) and (Cy-9) were obtained by the same methods as the pigment dispersion (Cy-1) except that the 3 parts of PAA-03 were changed to 0.2 parts and 8 parts in the manufacturing example of the pigment dispersion (Cy-1).

<Manufacturing Example of Pigment Dispersion (Cy-10)>

Pigment dispersion (Cy-10) was obtained by the same methods as the pigment dispersion (Cy-1) except that the 21 parts of Ajisper PB-817 (Ajinomoto Fine Techno) were replaced with 53 parts of Solsperse 13940 (40% solution, “S13940” in Table 3, Lubrizol Japan) in the manufacturing example of the pigment dispersion (Cy-1).

<Manufacturing Example of Pigment Dispersion (Cy-11)>

Pigment dispersion (Cy-11) was obtained by the same methods as the pigment dispersion (Cy-1) except that the binder resin (P-1) was replaced with the binder resin (P-2) in the manufacturing example of the pigment dispersion (Cy-1).

<Manufacturing Examples of Pigment Dispersions (Cy-12) to (Cy-16)>

Pigment dispersions (Cy-12) to (Cy-16) were obtained by the same methods as the pigment dispersion (Cy-1) except that the 21 parts of Ajisper PB-817 (Ajinomoto Fine Techno) were replaced with 53 parts of the toner particle dispersant (D-1), and the binder resin (P-1) was replaced with the binder resins (P-3) to (P-7) as shown in Table 3 in the manufacturing example of the pigment dispersion (Cy-1).

<Manufacturing Examples of Pigment Dispersions (M-1), (Y-1) and (Bk-1)>

Pigment dispersions (M-1), (Y-1) and (Bk-1) were obtained by the same methods as the pigment dispersion (Cy-1) except that the pigment blue 15:3 was replaced with pigment red 122, pigment yellow 155 and NiPex 35 (carbon black, Orion Engineered Carbons), respectively, in the manufacturing example of the pigment dispersion (Cy-1).

<Manufacturing Example of Toner Particle Dispersion (T-1)>

### (Mixing Step)

200 parts of Moresco White MT-30P (“MT30P” in Table 3, Matsumura Oil) were added gradually with a homogenizer OKA Ultra. Turrax T50) under high-speed stirring (rotation 25,000 rpm) to 100 parts of the pigment dispersion (Cy-1) obtained above to obtain a liquid mixture.

(Distillation Step)

The resulting mixture was transferred to a round-bottomed flask, and the tetrahydrofuran was completely distilled off at 50° C. under ultrasound dispersion to obtain a toner particle dispersion (T-1) comprising a toner particle dispersed in an insulating liquid.

<Manufacturing Examples of Toner Particle Dispersions (T-2) to (T-14)>

Toner particle dispersions (T-2) to (T-14) were obtained by the same methods as the toner particle dispersion (T-1) except that the pigment dispersion (Cy-1) was changed in each case as shown in Table 3 in the manufacturing example of the toner particle dispersion (T-1).

<Manufacturing Example of Toner Particle Dispersion (T-101)>

Toner particle dispersion (T-101) was obtained by the same methods as the toner particle dispersion (T-1) except that the 200 parts of Moresco White MT-30P were replaced with 200 parts of dodecyl vinyl ether (example compound A-3) in the manufacturing example of the toner particle dispersion (T-1).

<Manufacturing Examples of Toner Particle Dispersions (T-102) to (T-114)>

Toner particle dispersions (T-102) to (T-114) were obtained by the same methods as the toner particle dispersion (T-101) except that the pigment dispersion (Cy-1) was changed in each case as shown in Table 3 in the manufacturing example of the toner particle dispersion (T-101),

<Manufacturing Examples of Toner Particle Dispersions (T-115) to (T-119)>

Toner particle dispersions (T-115) to (T-119) were obtained by the same methods as the toner particle dispersion (T-1) except that the pigment dispersion (Cy-1) was replaced as shown in Table 3, and the 200 parts of Moresco White MT-30P were replaced with 200 parts of 1,12-octadecanediol divinyl ether (example compound A-31) in the manufacturing example of the toner particle dispersion (T-1),

[Liquid Developer Preparation Step]

### <Manufacturing Examples of Liquid Developers (LD-1) to (LD-14)>

10 parts each of the resulting toner particle dispersions (T-1) to (T-14) were centrifuged, and the supernatant was removed by decantation. Fresh Moresco White MT-30P was then added in the same mass as the removed supernatant, and the toner particle dispersions were re-dispersed. 0.10 parts of Resinol S-10 (hydrogenated lecithin, manufactured by Nikko Chemicals Co., Ltd.) were added to each of the resulting dispersions to obtain liquid developers (LD-1) to (LD-14).

<Manufacturing Examples of Liquid Developers (LD-101) to (LD-114)>

Liquid developers (LD-101) to (LD-114) were obtained by the same methods as the liquid developers (LD-1) to (LD-14) except that the toner particle dispersions (T-1) to (T-14) were replaced with the toner particle dispersions (T-101) to (T-114), and the Moresco White MT-30P was replaced with dodecyl vinyl ether example compound A-3) in the manufacturing examples of the liquid developers (LD-1) to (LD-14).

<Manufacturing Examples of Liquid Developers (LD-115) to (LD-119)>

Liquid developers (LD-115) to (LD-119) were obtained by the same methods as the liquid developers (LD-1) to (LD-14) except that the toner particle dispersions (T-1) to (T-14) were replaced with the toner particle dispersions (T-115) to (T-119), and the Moresco White MT-30P was replaced with 1,12-octadecanediol divinyl ether (example compound A-31) in the manufacturing examples of the liquid developers (LD-1) to (LD-14).

[Manufacturing Example of Comparative Liquid Developer B]

### <Manufacturing Example of Comparative Pigment Dispersion (Cy-001)>

A comparative pigment dispersion (Cy-001) was obtained by the same methods as the pigment dispersion (Cy-1) except that no PAA-03 (20% aqueous solution, Nittobo Medical Co., Ltd.) was added in the manufacturing example of the pigment dispersion (Cy-1).

<Manufacturing Examples of Comparative Pigment Dispersions (Cy-002) and (Cy-003)>

Comparative pigment dispersions (Cy-002) and (Cy-003) were obtained by the same methods as the pigment dispersion (Cy-1) except that the 3 parts of PAA-03 were replaced with 0.6 parts of Ajisper PB821 (Ajinomoto Fine Techno) and 0.6 parts of the Neutralized. PAA-03 2 (20% aqueous solution), respectively, in the manufacturing example of the pigment dispersion (Cy-1).

<Manufacturing Example of Comparative Pigment Dispersion (Cy-004)>

A comparative pigment dispersion (Cy-004) was obtained by the same methods as the pigment dispersion (Cy-1) except that (P-1) was replaced with Vylon 220 (“V220” in Table 3, Toyobo) in the manufacturing example of the pigment dispersion (Cy-1).

<Manufacturing Examples of Comparative Toner Particle Dispersions (T-001) to (T-004)>

Comparative toner particle dispersions (T-001) to (T-004) were obtained by the same methods as the toner particle dispersion (T-1) except that the pigment dispersion (Cy-1) was replaced with the comparative pigment dispersions (Cy-001) to (Cy-004) in the manufacturing example of the toner particle dispersion (T-1)

<Manufacturing Examples of Comparative Toner Particle Dispersions (T-005) to (T-008)=>

Comparative toner particle dispersions (T-005) to (T-008) were obtained by the same methods as the comparative toner particle dispersions (T-001) to (T-004) except that the 200 parts of Moresco White MT-30P were replaced with 200 parts of dodecyl vinyl ether (example compound A-3) in the manufacturing examples of the comparative toner particle dispersions T-001) to (T-004).

<Manufacturing Examples of Comparative Liquid Developers (LD-001) to (LD-004)>

Comparative liquid developers (LD-001) to (LD-004) were obtained by the same methods as the liquid developer (LD-1) except that the comparative toner particle dispersions (T-001) to (T-004) were substituted for the toner particle dispersion (T-1) in the manufacturing example of the liquid developer (LD-1).

<Manufacturing Examples of Comparative Liquid Developers (LD-005) to (LD-008)>

Comparative liquid developers (LD-005) to (LD-008) were obtained by the same methods as the liquid developer (LD-101) except that the comparative toner particle dispersions (T-005) to (T-008) were substituted for the toner particle dispersion (T-101) in the manufacturing example of the liquid developer (LD-101).

Compositions of comparative liquid developers (LD-001) to (LD-008) are shown in Table 3.

### Examples B1 to B33

The liquid developers (LD-1) to (LD-14) and (LD-101) to (LD-119) above were evaluated by the following methods. The evaluation results are shown in Table 3.

### Comparative Examples B1 to B8

The comparative liquid developers (LD-001) to (LD-008) were evaluated by the following methods. The evaluation results are shown in Table 3.

<Evaluation of Dispersion Stability>

The volume-based 50% particle diameter (1?50, unit: μm) of the toner particle in the liquid developer was measured with a laser diffraction/scattering type particle size distribution measuring device (product name LA-950, Horiba, Ltd.).

The evaluation standard is shown below.

### 5: (D50)≤1.0

### 4: 1.0<(D50)≤1.2

### 3: 1.2<(D50)≤1.5

### 2: 1.5<(D50)≤2.0

### 1: 2.0<(D50)

<Evaluation of Surface Smoothness>

The external appearance of the toner particle in the liquid developer was observed under a scanning electron microscope (SEM, product name “S-4800”, JEOL).

The evaluation standard is shown below.

3: No surface irregularities observed on toner particle.
2: Slight surface irregularities on toner particle.
1: Obvious surface irregularities on toner particle.

<Evaluation of Developing Performance>

Developing was performed by the following methods using the liquid developers. The developing apparatus 50C shown in the FIGURE was used as the apparatus.

(1) With the developing roller 53C, photosensitive drum 52C and intermediate transfer roller 61C separated and not touching, these were rotated in the direction shown by the arrow in the FIGURE. The rotation speed at this time was 250 mm/sec.

(2) The developing roller 53C and photosensitive drum 52C were brought into contact under a constant pressure, and the developing bias was set to 200 V with a DC power source.

(3) The photosensitive drum 52C and intermediate transfer roller 61C were brought into contact under a constant pressure, and the transfer bias was set to 1000 V with a DC power source.

(4) A uniform amount (100 mL) of a liquid developer with a uniform concentration (toner particle concentration 2 mass % was supplied to a film-forming roller (not shown), and the image formed on the intermediate transfer member 60C was evaluated.

The evaluation standard for developing performance is given below.

3: High-density, high-definition image obtained.
2: Some density irregularity or some image blurring.
1: Appears developed, but obvious density irregularity or image blurring.

The evaluation results are shown in Table 3. “Comparative Example B4” and “Comparative Example B8” could not be evaluated because granulation was insufficient.

TABLE 3

| | | | | | | | | | Polyamine compound | | | | | | | |
|---|---|---|---|---|---|---|---|---|---|---|---|---|---|---|---|---|
| Example | | | | Binder resin | | | | | | Amine | | | | | | |
| Comparative | | Toner | | | Acid | | | Toner | | value | Added | | | | | |
| Example | Liquid | particle | Pigment | | value | | | particle | | of solids | amount | Insulating | | Dispersion | Surface | |
| No. | developer | dispersion | dispersion | Type | [mgKOH/g] | Mn | Mw | dispersant | Type | [mgKOH/g] | [part] | liquid | Solvent | stability | smoothness | Development |
| B1 | LD-1 | T-1 | Cy-1 | P-1 | 21 | 2420 | 18300 | PB817 | PAA-03 | 948 | 3 | MT30P | THF | 5 | 3 | 3 |
| B2 | LD-2 | T-2 | Cy-2 | P-1 | 21 | 2420 | 18300 | PB817 | PAA-01 | 948 | 4 | MT30P | THF | 5 | 3 | 3 |
| B3 | LD-3 | T-3 | Cy-3 | P-1 | 21 | 2420 | 18300 | PB817 | PAA-05 | 948 | 3 | MT30P | THF | 5 | 3 | 3 |
| B4 | LD-4 | T-4 | Cy-4 | P-1 | 21 | 2420 | 18300 | PB817 | SP-003 | 1134 | 0.6 | MT30P | THF | 4 | 2 | 2 |
| B5 | LD-5 | T-5 | Cy-5 | P-1 | 21 | 2420 | 18300 | PB817 | PVAM-0595B | 1262 | 6 | MT30P | THF | 4 | 2 | 2 |
| B6 | LD-6 | T-6 | Cy-6 | P-1 | 21 | 2420 | 18300 | PB817 | Neutralized | 473 | 3 | MT30P | THF | 4 | 2 | 2 |
| | | | | | | | | | PAA-03 1 | | | | | | | |
| B7 | LD-7 | T-7 | Cy-7 | P-1 | 21 | 2420 | 18300 | PB817 | Polyaniline | 608 | 0.6 | MT30P | THF | 3 | 2 | 2 |
| B8 | LD-8 | T-8 | Cy-8 | P-1 | 21 | 2420 | 18300 | PB817 | PAA-03 | 948 | 0.2 | MT30P | THF | 5 | 3 | 3 |
| B9 | LD-9 | T-9 | Cy-9 | P-1 | 21 | 2420 | 18300 | PB817 | PAA-03 | 948 | 8 | MT30P | THF | 5 | 3 | 3 |
| B10 | LD-10 | T-10 | Cy-10 | P-1 | 21 | 2420 | 18300 | S13940 | PAA-03 | 948 | 3 | MT30P | THF | 5 | 3 | 2 |
| B11 | LD-11 | T-11 | Cy-11 | P-2 | 112 | 6190 | 19930 | PB817 | PAA-03 | 948 | 3 | MT30P | THF | 4 | 3 | 2 |
| B12 | LD-12 | T-12 | M-1 | P-1 | 21 | 2420 | 18300 | PB817 | PAA-03 | 948 | 3 | MT30P | THF | 5 | 3 | 3 |
| B13 | LD-13 | T-13 | Y-1 | P-1 | 21 | 2420 | 18300 | PB817 | PAA-03 | 948 | 3 | MT30P | THF | 5 | 3 | 3 |
| B14 | LD-14 | T-14 | Bk-1 | P-1 | 21 | 2420 | 18300 | PB817 | PAA-03 | 948 | 3 | MT30P | THF | 5 | 3 | 3 |
| B15 | LD-101 | T-101 | Cy-1 | P-1 | 21 | 2420 | 18300 | PB817 | PAA-03 | 948 | 3 | (A-3) | THF | 5 | 3 | 3 |
| B16 | LD-102 | T-102 | Cy-2 | P-1 | 21 | 2420 | 18300 | PB817 | PAA-01 | 948 | 4 | (A-3) | THF | 5 | 3 | 3 |
| B17 | LD-103 | T-103 | Cy-3 | P-1 | 21 | 2420 | 18300 | PB817 | PAA-05 | 948 | 3 | (A-3) | THF | 5 | 3 | 3 |
| B18 | LD-104 | T-104 | Cy-4 | P-1 | 21 | 2420 | 18300 | PB817 | SP-003 | 1134 | 0.6 | (A-3) | THF | 4 | 2 | 2 |
| B19 | LD-105 | T-105 | Cy-5 | P-1 | 21 | 2420 | 18300 | PB817 | PVAM-0595B | 1262 | 6 | (A-3) | THF | 4 | 2 | 2 |
| B20 | LD-106 | T-106 | Cy-6 | P-1 | 21 | 2420 | 18300 | PB817 | Neutralized | 473 | 3 | (A-3) | THF | 4 | 2 | 2 |
| | | | | | | | | | PAA-03 1 | | | | | | | |
| B21 | LD-107 | T-107 | Cy-7 | P-1 | 21 | 2420 | 18300 | PB817 | Polyaniline | 608 | 0.6 | (A-3) | THF | 3 | 2 | 2 |
| B22 | LD-108 | T-108 | Cy-8 | P-1 | 21 | 2420 | 18300 | PB817 | PAA-03 | 948 | 0.2 | (A-3) | THF | 5 | 3 | 3 |
| B23 | LD-109 | T-109 | Cy-9 | P-1 | 21 | 2420 | 18300 | PB817 | PAA-03 | 948 | 8 | (A-3) | THF | 5 | 3 | 3 |
| B24 | LD-110 | T-110 | Cy-10 | P-1 | 21 | 2420 | 18300 | S13940 | PAA-03 | 948 | 3 | (A-3) | THF | 5 | 3 | 2 |
| B25 | LD-111 | T-111 | Cy-11 | P-2 | 112 | 6190 | 19930 | PB817 | PAA-03 | 948 | 3 | (A-3) | THF | 4 | 3 | 2 |
| B26 | LD-112 | T-112 | M-1 | P-1 | 21 | 2420 | 18300 | PB817 | PAA-03 | 948 | 3 | (A-3) | THF | 5 | 3 | 3 |
| B27 | LD-113 | T-113 | Y-1 | P-1 | 21 | 2420 | 18300 | PB817 | PAA-03 | 948 | 3 | (A-3) | THF | 5 | 3 | 3 |
| B28 | LD-114 | T-114 | Bk-1 | P-1 | 21 | 2420 | 18300 | PB817 | PAA-03 | 948 | 3 | (A-3) | THF | 5 | 3 | 3 |
| B29 | LD-115 | T-115 | Cy-12 | P-3 | 15 | 6610 | 24600 | D-1 | PAA-03 | 948 | 3 | (A-31) | THF | 5 | 3 | 3 |
| B30 | LD-116 | T-116 | Cy-13 | P-4 | 12 | 6230 | 21500 | D-1 | PAA-03 | 948 | 3 | (A-31) | THF | 5 | 3 | 3 |
| B31 | LD-117 | T-117 | Cy-14 | P-5 | 11 | 6710 | 25200 | D-1 | PAA-03 | 948 | 3 | (A-31) | THF | 5 | 3 | 3 |
| B32 | LD-118 | T-118 | Cy-15 | P-6 | 10 | 6680 | 24300 | D-1 | PAA-03 | 948 | 3 | (A-31) | THF | 5 | 3 | 3 |
| B33 | LD-119 | T-119 | Cy-16 | P-7 | 18 | 6550 | 23700 | D-1 | PAA-03 | 948 | 3 | (A-31) | THF | 5 | 3 | 3 |
| Comparative | LD-001 | T-001 | Cy-001 | P-1 | 21 | 2420 | 18300 | PB817 | — | | — | MT30P | THF | 1 | 1 | 1 |
| B1 | | | | | | | | | | | | | | | | |
| Comparative | LD-002 | T-002 | Cy-002 | P-1 | 21 | 2420 | 18300 | PB817 | PB821 | 8-10 | 0.6 | MT30P | THF | 1 | 1 | 1 |
| B2 | | | | | | | | | | | | | | | | |
| Comparative | LD-003 | T-003 | Cy-003 | P-1 | 21 | 2420 | 18300 | PB817 | Neutralized | 235 | 0.6 | MT30P | THF | 2 | 1 | 1 |
| B3 | | | | | | | | | PAA-03 2 | | | | | | | |
| Comparative | LD-004 | T-004 | Cy-004 | V220 | <2 | 2420 | Not | PB817 | PAA-03 | 948 | 3 | MT30P | THF | — | — | — |
| B4 | | | | | | | measured | | | | | | | | | |
| Comparative | LD-005 | T-005 | Cy-001 | P-1 | 21 | 2420 | 18300 | PB817 | — | | — | (A-3) | THF | 1 | 1 | 1 |
| B5 | | | | | | | | | | | | | | | | |
| Comparative | LD-006 | T-006 | Cy-002 | P-1 | 21 | 2420 | 18300 | PB817 | PB821 | 8-10 | 0.6 | (A-3) | THF | 1 | 1 | 1 |
| B6 | | | | | | | | | | | | | | | | |
| Comparative | LD-007 | T-007 | Cy-003 | P-1 | 21 | 2420 | 18300 | PB817 | Neutralized | 235 | 0.6 | (A-3) | THF | 2 | 1 | 1 |
| B7 | | | | | | | | | PAA-03 2 | | | | | | | |
| Comparative | LD-008 | T-008 | Cy-004 | V220 | <2 | 3000 | Not | PB817 | PAA-03 | 948 | 3 | (A-3) | THF | — | — | — |
| B8 | | | | | | | measured | | | | | | | | | |

With the present invention, it is possible to provide a liquid developer excellent in image quality, fixability and storage stability and having a toner particle with both good dispersion stability and good surface smoothness, as well as a method for manufacturing the liquid developer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A liquid developer containing an insulating liquid and a toner particle that is insoluble in the insulating liquid, wherein
the toner particle contains:
a polyamine compound, and
a binder resin and a colorant having an acidic group, or a colorant and a binder resin having an acidic group,
the polyamine compound is a compound that is insoluble in the insulating liquid, and
the amine value of the polyamine compound is at least 300 mgKOH/g.

2. The liquid developer according to claim 1, wherein the polyamine compound contains at least one selected from the group consisting of polyethylenimine compounds, polyvinylamine compounds, polyallylamine compounds, and salts of these compounds.

3. The liquid developer according to claim 1, wherein the polyamine compound contains a polyallylamine compound.

4. The liquid developer according to claim 1, wherein the content of the polyamine compound in the toner particle is from 0.01 mass parts to 10 mass parts per 100 mass parts of the colorant having an acidic group or the binder resin having an acidic group.

5. The liquid developer according to claim 1, wherein the acid value of the binder resin having an acidic group is at least 5 mgKOH/g.

6. The liquid developer according to claim 1, wherein the binder resin having an acidic group contains a polyester resin.

7. The liquid developer according to claim 1, wherein
the liquid developer further contains a toner particle dispersant,
the toner particle dispersant is dissolved in the insulating liquid, and
the toner particle dispersant contains a polymer having a monomer unit represented by the following formula (1) and a monomer unit represented by the following formula (2):
K (1)
where K represents a monomer unit having a primary amino group; and
Q (2)
where Q represents a monomer unit containing an optionally substituted alkyl group having 6 or more carbon atoms, an optionally substituted cycloalkyl group having 6 or more carbon atoms, an optionally substituted alkylene group having 6 or more carbon atoms, or an optionally substituted cycloalkylene group having 6 or more carbon atoms.

8. The liquid developer according to claim 7, wherein the toner particle dispersant contains a reaction product of polyallyalmine and a self-condensate of 12-hydroxystearic acid.

9. The liquid developer according to claim 1, wherein the liquid developer further contains a cationically polymerizable liquid monomer and a photopolymerization initiator represented by the following formula (3), and
the colorant having an acidic group contains a carbon black, 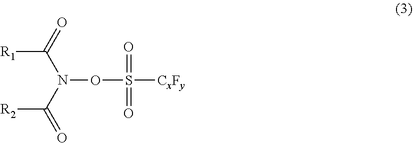
where R₁ and R₂ bind together to form a cyclic structure, x represents an integer of from 1 to 8, and y represents an integer of from 3 to 17.

10. The liquid developer according to claim 9, wherein the pH of the carbon black is at least 8.0.

11. A method for manufacturing a liquid developer containing
an insulating liquid and
a toner particle that contains:
a polyamine compound, and
a binder resin and a colorant having an acidic group, or a colorant and a binder resin having an acidic group,
the method comprising:
a step 1 of preparing a mixture containing:
an insulating liquid,
a binder resin and a colorant having an acidic group, or a colorant and a binder resin having an acidic group,
a polyamine compound, and
a solvent; and
a step 2 of removing the solvent from the mixture, wherein
the binder resin does not dissolve in the insulating liquid but dissolves in the solvent,
the polyamine compound is a compound that is insoluble in the insulating liquid, and
the amine value of the polyamine compound is at least 300 mgKOH/g.

12. The liquid developer manufacturing method according to claim 11, wherein the polyamine compound contains at least one selected from the group consisting of polyethylenimine compounds, polyvinylamine compounds, polyallylamine compounds, and salts of these compounds.

13. The liquid developer manufacturing method according to claim 11, wherein the polyamine compound contains a polyallylamine compound.

14. The liquid developer manufacturing method according to claim 11, wherein the content of the polyamine compound in the toner particle is from 0.01 mass parts to 10 mass parts per 100 mass parts of the colorant having an acidic group or the binder resin having an acidic group.

15. The liquid developer manufacturing method according to claim 11, wherein the acid value of the binder resin having an acidic group is at least 5 mgKOH/g.

16. The liquid developer manufacturing method according to claim 11, wherein the binder resin contains a polyester resin.

17. The liquid developer manufacturing method according to claim 11, wherein the mixture further contains a toner particle dispersant that dissolves in both the insulating liquid and the solvent, and a colorant dispersant that does not dissolve in the insulating liquid but dissolves in the solvent.

18. The liquid developer manufacturing method according to claim 11, wherein the toner particle dispersant contains a polymer having a monomer unit represented by the following formula (1) and a monomer unit represented by the following formula (2), and
the amine value derived from a primary amine contained in the monomer unit represented by the following formula (1) is at least 50% of the amine value of the toner particle dispersant,
K (1)
where K represents a monomer unit having a primary amino group; and
Q (2)
where Q represents a monomer unit containing an optionally substituted alkyl group having 6 or more carbon atoms, an optionally substituted cycloalkyl group having 6 or more carbon atoms, an optionally substituted alkylene group having 6 or more carbon atoms, or an optionally substituted cycloalkylene group having 6 or more carbon atoms.

19. The liquid developer manufacturing method according to claim 11, wherein the insulating liquid further contains a cationically polymerizable liquid monomer and a photopolymerization initiator represented by the following formula (3), and
the colorant having an acidic group contains a carbon black, 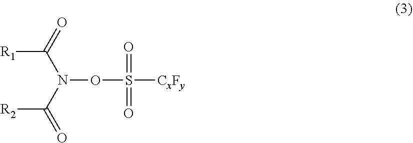
where R₁ and R₂ bind together to form a cyclic structure, x represents an integer of from 1 to 8, and y represents an integer of from 3 to 17.

20. The liquid developer manufacturing method according to claim 19, wherein the pH of the carbon black is at least 8.0.
